(19) United States
(12) Patent Application Publication
(10) Pub. No.: US 2026/0261600 A1
(43) Pub. Date: Sep. 3, 2026

(54) SMF NODE, AF NODE, UE, AND METHODS THEREOF

(71) Applicant: NEC Corporation, Tokyo (JP)

(72) Inventors: Tsuyoshi TAKAKURA, Tokyo (JP); Toshlyuki Tamura, Tokyo (JP)

(73) Assignee: NEC Corporation, Tokyo (JP)

(21) Appl. No.: 19/654,679

(22) Filed: Apr. 22, 2026

Related U.S. Application Data
(63) Continuation of application No. 18/290,236, filed on Mar. 31, 2022.

(30) Foreign Application Priority Data
May 18, 2021 (JP) 2021-084233

(51) Int. Cl. H04L 67/143

(52) U.S. Cl. CPC H04L 67/143

(57) ABSTRACT

Session Management Function (SMF) (32) detects an event related to an Application Context Relocation (ACR) procedure after receiving a first event notification from an Access and Mobility management Function (AMF) (31) indicating that a User Equipment (UE) (1) is out of an Edge Data Network (EDN) service area or out of a Local Area Data Network (LADN) service area. In response to detecting the event related to the ACR procedure, the SMF (32) initiates a procedure for releasing a PDU Session for the LADN or EDN, or a procedure for deactivating a UP connection for the PDU Session. For example, this can help prevent a failed ACR procedure when a UE moves between EDNs (or LADNs).

### DESCRIPTION

This application is a continuation application of United States Patent Application Ser. No. 18/290,236 filed on November 10, 2023, which is a National Stage Entry of PCT/JP2022/016629 filed on March 31, 2022, which claims priority from JP Patent Application 2021-084223 filed on May 18, 2021, the contents of all of which are incorporated herein by reference, in their entirety.

### TECHNICAL FIELD

The present disclosure relates to a radio communication network, and in particular to PDU Session management.

### BACKGROUND ART

The 5G system (5GS) connects a radio terminal (User Equipment (UE)) to a Data Network (DN). In the 5G architecture, connectivity services between the UE and the DN are supported by one or more Protocol Data Unit (PDU) Sessions (see, for example, Non-Patent Literature 1 and 2). A PDU Session is an association, session, or connection between the UE and the DN. A PDU Session is used to provide a PDU connectivity service (i.e., exchange of PDUs between the UE and the DN). A PDU Session is established between the UE and a User Plane Function (UPF) (i.e., PDU Session anchor) to which the DN is connected. From a data transfer perspective, a PDU Session consists of a tunnel (N9 tunnel) in the 5G Core Network (5GC), a tunnel (N3 tunnel) between the 5GC and an Access Network (AN), and one or more radio bearers.

Non-Patent Literature 2 specifies PDU Session establishment procedures and PDU Session release procedures. More specifically, PDU Session establishment procedures are described, for example, in Section 4.3.2.2 of Non-Patent Literature 2. PDU Session release procedures are described, for example, in Section 4.3.4.2 of Non-Patent Literature 2. In addition, Non-Patent Literature 2 specifies a procedure for deactivating user-plane (UP) connections (or resources) for a PDU Session. This procedure is described, for example, in Section 4.3.7 of Non-Patent Literature 2.

The 5GS supports a Local Area Data Network (LADN). An overview of LADN is provided, for example, in Section 5.6.5 of Non-Patent Literature 1. Access to a DN via a PDU Session for a LADN is only available in a particular (or specific) LADN service area. The LADN service area is a set of one or more Tracking Areas (TAs) belonging to the UE's current registration area. If the UE has moved out of the LADN service area, a Session Management Function (SMF) shall release the PDU Session for that LADN or deactivate the UP connection for that PDU Session. A UP connection (or resources) includes a data radio bearer in a Radio Access Network (RAN) and an N3 tunnel between the RAN and a UPF. Deactivating a UP connection means releasing the data radio bearer in a Radio Access Network ((R)AN) and an N3 tunnel between the (R)AN and a UPF that make up the UP connection. Similarly, activating a UP connection means establishing (or configuring) a data radio bearer in a (R)AN and an N3 tunnel between the (R)AN and a UPF that form the UP connection.

The Third Generation Partnership Project (3GPP) SA6 working group has begun standardization work on an architecture for enabling Edge Applications. (See, for example, Non-Patent Literature 3). This 3GPP architecture is called the EDGEAPP architecture. The EDGEAPP architecture provides a specification of an enabling layer to facilitate communication between application clients (ACs) running on a UE and applications deployed at the edge. According to the EDGEAPP architecture, edge applications provided by Edge Application Servers (EASs) are provided to ACs in a UE by an Edge Configuration Server (ECS) and an Edge Enabler Server (EES) through an Edge Enabler Client (EEC) of that UE.

As described in Section A.2 of Non-Patent Literature 3, there are various deployment models for DN implementations. In one example, edge computing services can be provided via Edge-dedicated Data Networks deployed as LADNs (see Section A.2.4 of Non-Patent Literature 3). With this option, a Public Land Mobile Network (PLMN) supports edge computing services in an Edge Data Network (EDN) service area, which is the same as an LADN service area. The LADN service area is a service area where edge computing is supported. An individual EAS within the LADN can support a service area equal to or smaller than the LADN.

The EDGEAPP architecture supports various Application Context Relocation (ACR) procedures for service continuity. The application context is the set of data present in an EAS and related to an AC. Application context relocation involves transferring the application context from a source EAS (or old EDN or old LADN) to a target EAS (or new EDN or new LADN). Application context relocation is triggered by UE mobility events or non-UE mobility events. UE mobility events include, for example, intra-EDN mobility, inter-EDN mobility, and Local Area Data Network (LADN)-related mobility. Non-UE mobility events include, for example, EAS or EDN overload conditions and EAS maintenance (e.g., graceful shutdown of the EAS).

### Citation List

### Non Patent Literature

[Non-Patent Literature 1] 3GPP TS 23.501 V17.0.0 (2021-03) "3rd Generation Partnership Project; Technical Specification Group Services and System Aspects; System Architecture for the 5G System (5GS); Stage 2 (Release 17)", March 2021

[Non-Patent Literature 2] 3GPP TS 23.502 V17.0.0 (2021-03) "3rd Generation Partnership Project; Technical Specification Group Services and System Aspects; Procedures for the 5G System (5GS); Stage 2 (Release 17)", March 2021

[Non-Patent Literature 3] 3GPP TS 23.558 V2.0.0 (2021-03) "3rd Generation Partnership Project; Technical Specification Group Services and System Aspects; Architecture for enabling Edge Applications; (Release 17)", March 2021

[Non-Patent Literature 4] 3GPP TS 23.503 V17.0.0 (2021-03) "3rd Generation Partnership Project; Technical Specification Group Services and System Aspects; Policy and charging control framework for the 5G System (5GS); Stage 2 (Release 17)", March 2021

### SUMMARY OF INVENTION

### Technical Problem

The inventors have studied deployment models where edge computing services are provided via edge-dedicated data networks and found various issues. One of these issues relates to Application Context Relocation (ACR).

Specifically, when a UE moves from one EDN (or LADN) to another EDN (or LADN), in other words, when a UE switches from a connection to one EDN (or LADN) to a connection to another EDN (or LADN), it may be desirable to be able to perform Application Context Relocation (ACR) between these two EDNs (or LADNs). In other words, it may be desirable for the application context to be transferred or taken over from a Source EAS (S-EAS) in the old EDN (or LADN) to a Target EAS (T-EAS) in the new EDN (or LADN). However, if the UE moves out of the current EDN service area or out of the current LADN service area, the SMF shall release the PDU Session corresponding to that EDN (or LADN) or deactivate the UP connection (or resources) for that PDU Session. Once the PDU Session is released or the UP connection is deactivated for the old EDN (or LADN), the UE (or EEC) may no longer be able to communicate with the Source EES (S-EES) in the old LADN. The ACR procedure with signaling between the UE (or EEC) and the S-EES may then not be able to complete successfully. For example, in ACR initiated by the EEC and ACs (see Non-Patent Literature 3, Section 8.8.2.2, FIG. 8.8.2.3-1), the UE (or EEC) may not be able to send the ACR Request message (Step 5) to the S-EES.

One of the objects to be achieved by example embodiments disclosed herein is to provide apparatuses, methods, and programs that contribute to the prevention of a failed ACR procedure when a UE moves between EDNs (or LADNs). It should be noted that this object is merely one of the objects to be achieved by the example embodiments disclosed herein. Other objects or problems and novel features will be become apparent from the following description and the accompanying drawings.

### Solution to Problem

In a first aspect, an SMF node includes a memory and at least one processor coupled to the memory. The at least one processor is configured to detect an event related to an Application Context Relocation (ACR) procedure after receiving a first event notification from an AMF node indicating that a UE is out of an EDN service area or out of an LADN service area. The at least one processor is further configured to, in response to detecting the event related to the ACR procedure, initiate a procedure for releasing a PDU Session for an LADN associated with the LADN service area, a procedure for releasing a PDU Session for an EDN associated with the EDN service area, or a procedure for deactivating a UP connection for the PDU Session.

In a second aspect, a method performed by an SMF node includes: a) detecting an event related to an ACR procedure after receiving a first event notification from an AMF node indicating that a UE is out of an EDN service area or out of an LADN service area; and b) in response to detecting the event related to the ACR procedure, initiating a procedure for releasing a PDU Session for an LADN associated with the LADN service area, a procedure for releasing a PDU Session for an EDN associated with the EDN service area, or a procedure for deactivating a UP connection for the PDU Session.

In a third aspect, an AMF node includes a memory and at least one processor coupled to the memory. The at least one processor is configured to receive an event notification from an SMF node directly or through a Network Exposure Function (NEF) node. The at least one processor is further configured to send a response to the event notification to the SMF node directly or through the NEF node after an ACR procedure involving a transfer of an application context from a S-EAS to a T-EAS is completed. The response is a message that causes the SMF node to initiate a procedure for releasing a PDU Session for an LADN, a procedure for releasing a PDU Session for an EDN, or a procedure for deactivating a UP connection for the PDU Session.

In a fourth aspect, a method performed by an AMF node includes: a) receiving an event notification from an SMF node directly or through a NEF node; and b) sending a response to the event notification to the SMF node directly or through the NEF node after an ACR procedure involving a transfer of an application context from a S-EAS to a T-EAS is completed. The response is a message that causes the SMF node to initiate a procedure for releasing a PDU Session for an LADN, a procedure for releasing a PDU Session for an EDN, or a procedure for deactivating a UP connection for the PDU Session.

In a fifth aspect, a UE includes a memory and at least one processor coupled to the memory. The at least one processor is configured to, if a first Data Network Name (DNN) corresponds to an LADN of a given type, select a mode for continuity of session and service. The at least one processor is further configured to send a Non-Access Stratum (NAS) message containing a PDU Session Establishment Request indicating the selected mode to an AMF node to request an establishment of a first PDU Session for the first DNN. The mode for continuity of session and service comprises establishing a second PDU Session for a second DNN to which an application context is transferred from the first DNN before the first PDU Session is released when the UE has moved out of an LADN service area corresponding to the first DNN.

In a sixth aspect, a method performed by a UE includes: a) if a first DNN corresponds to an LADN of a given type, selecting a mode for continuity of session and service; and b) sending a NAS message containing a PDU Session Establishment Request indicating the selected mode to an AMF node to request an establishment of a first PDU Session for the first DNN. The mode for continuity of session and service comprises establishing a second PDU Session for a second DNN to which an application context is transferred from the first DNN before the first PDU Session is released when the UE has moved out of an LADN service area corresponding to the first DNN.

In a seventh aspect, a UE includes a memory and at least one processor coupled to the memory. The at least one processor is configured to provide EEC functionality. The EEC functionality comprises determining which of a plurality of ACR procedures to perform, considering that the UE has moved out of an LADN service area associated with a first EDN.

In an eighth aspect, a method performed by a UE includes providing EEC functionality. The EEC functionality comprises determining which of a plurality of ACR procedures to perform, considering that the UE has moved out of an LADN service area associated with a first EDN.

In a ninth aspect, a program includes instructions (software codes) that, when loaded into a computer, cause the computer to perform the method according to the above-described second, fourth, sixth, or eighth aspect.

### Advantageous Effects of Invention

According to the above-described aspects, it is possible to provide apparatuses, methods, and programs that contribute to the prevention of a failed ACR procedure when a UE moves between EDNs (or LADNs).

### BRIEF DESCRIPTION OF DRAWINGS

FIG. 1 shows a configuration example of a radio communication network according to an embodiment;

FIG. 2 shows an example of a deployment model for EDNs according to an example embodiment;

FIG. 3 shows an example of the 3GPP EDGEAPP architecture according to an example embodiment;

FIG. 4 is a flowchart showing an example of the operation of an SMF according to an example embodiment;

FIG. 5 is a flowchart showing an example of the operation of an SMF according to an example embodiment;

FIG. 6 is a flowchart showing an example of the operation of an AF according to an example embodiment;

FIG. 7 is a sequence diagram showing an example of the operation of an AMF, SMF, NEF, and AF according to an example embodiment;

FIG. 8 is a sequence diagram showing an example of the operation of an SMF, NEF, and AF according to an example embodiment;

FIG. 9 is a flowchart showing an example of the operation of an SMF according to an example embodiment;

FIG. 10 is a sequence diagram showing an example of the operation of an AMF, SMF, NEF, and AF according to an example embodiment;

FIG. 11 is a flowchart showing an example of the operation of an SMF according to an example embodiment;

FIG. 12 is a sequence diagram showing an example of the operation of an AMF and SM according to an example embodiment;

FIG. 13 is a flowchart showing an example of the operation of a UE according to an example embodiment;

FIG. 14 is a flowchart showing an example of the operation of an EEC in a UE according to an embodiment.

FIG. 15 is a block diagram showing an example configuration of a UE according to an example embodiment; and

FIG. 16 is a block diagram showing an example configuration of an AMF, SMF, NEF, and AF according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are described primarily for the 3GPP system (e.g., 5G system (5GS)). However, these example embodiments may be applied to other radio communication systems.

### First Example Embodiment

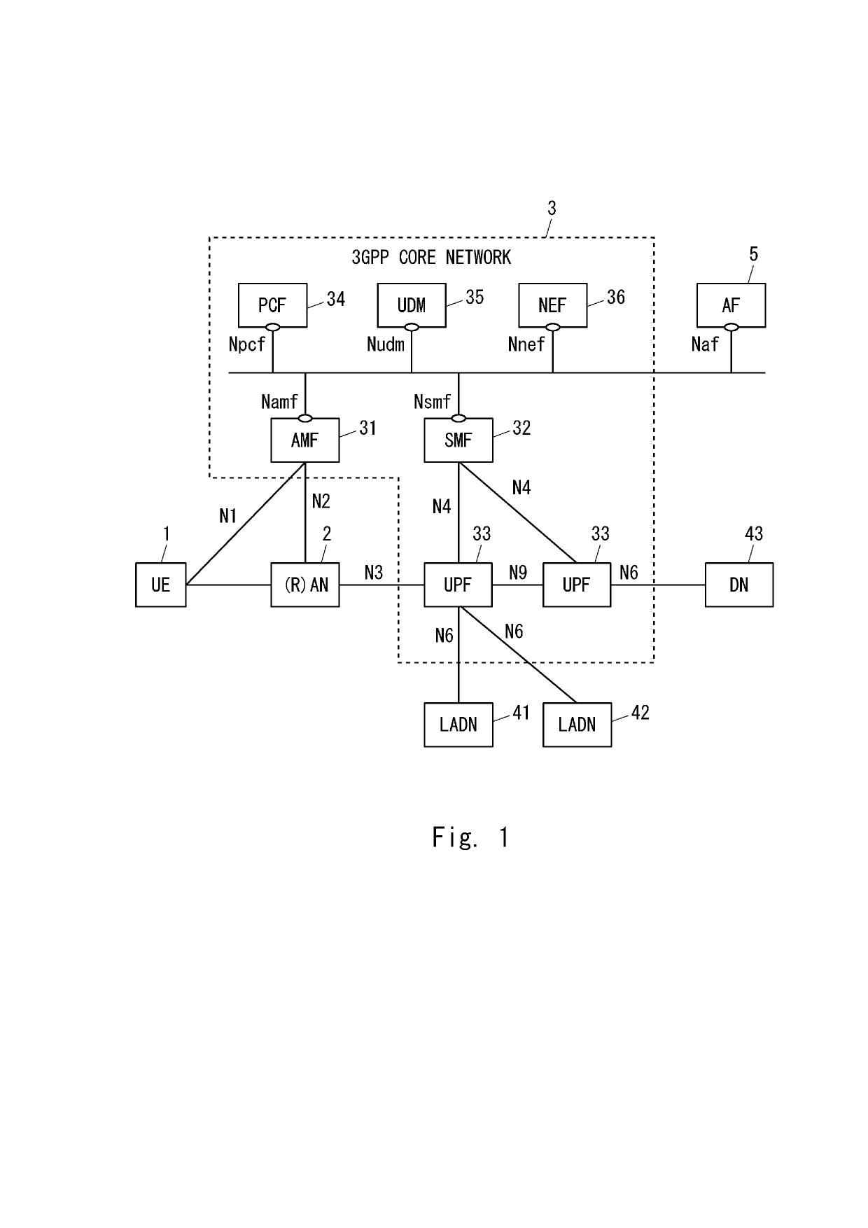

FIG. 1 shows an example configuration of a radio communication network (i.e., 5GS) according to this example embodiment. The elements shown in FIG. 1 are network functions and provides interfaces as defined by the 3GPP. Each of the elements (network functions) shown in FIG. 1 can be implemented, for example, as a network element on dedicated hardware, as a software instance running on dedicated hardware, or as a virtual function instantiated on an application platform.

The radio communication network shown in FIG. 1 may be provided by a Mobile Network Operator (MNO), or it may be a Non-Public Network (NPN) provided by a non-MNO. If the radio communication network shown in FIG. 1 is an NPN, it may be an independent network, represented as a Stand-alone Non-Public Network (SNPN), or it may be an NPN connected to an MNO network, represented as a public network integrated NPN.

A radio terminal (i.e., UE) 1 communicates with a data network (DN) using 3GPP (e.g., 5G) connectivity services. More specifically, the UE 1 is connected to a (radio) access network (e.g., 5G Access Network (5GAN)) 2 and communicates with a DN via or more User Plane Functions (UPFs) 33 in a 3GPP core network 3 (e.g., 5G core network (5GC)). FIG. 1 shows a case where two UPFs 33 are arranged in series, but this is an example. There may be only one UPF 33, or two or more UPFs 33 may be arranged in parallel. The 3GPP core network 3 may be, for example, but not limited to, 5GC. The 3GPP core network 3 may include networks other than 5G (e.g., future 6G or non-3GPP).

The UE 1 can communicate with multiple DNs simultaneously. As an example, FIG. 1 shows three DNs, namely LADN 41, LADN 42, and DN 43. The UE 1 may communicate with one or more of the LADN 41, LADN 42, and DN 43 simultaneously. However, the UE 1 is allowed to access the LADN 41 via a PDU Session for the LADN 41 only when the UE 1 is within the LADN service area of the LADN 41. Similarly, the UE 1 is allowed to access the LADN 42 via a PDU Session for the LADN 42 only when the UE 1 is within the LADN service area of the LADN 42. A LADN service area is a set of one or more Tracking Areas (TAs) belonging to the current registration area of the UE.

In the 3GPP system architecture for 5G and beyond, connectivity services between the UE 1 and one DN are supported by one or more Protocol Data Unit (PDU) Sessions. A PDU Session is an association, session, or connection between the UE 1 and the DN. A PDU Session is used to provide a PDU connectivity service (i.e., exchange of PDUs between the UE 1 and the DN). The UE 1 establishes one or more PDU Sessions between the UE 1 and a UPF 33 (i.e., PDU Session anchor) to which the DN is connected. From a data transfer perspective, a PDU Session consists of a tunnel within the 3GPP core network 3 (i.e., N9 tunnel), a tunnel between the 3GPP core network 3 and the AN 2 (i.e., N3 tunnel), and one or more radio bearers between the UE 1 and the AN 2. Although not shown in FIG. 1, the UE 1 may establish multiple PDU Sessions with multiple (PSA) UPFs 33 in order to simultaneously (or concurrently) access multiple DNs or (sub)networks (or entities) (e.g., LADNs 41 and DN 43) indicated by multiple Data Network Access Identifiers (DNAIs).

An Access and Mobility management Function (AMF) 31 is one of the network function nodes in the control plane of the 3GPP core network 3. The AMF 31 provides termination for a RAN Control Plane (CP) interface (i.e., N2 interface). The AMF 31 terminates a single signalling connection (i.e., N1 NAS signalling connection) with the UE 1 and provides registration management, connection management, and mobility management. The AMF 31 provides NF services to NF consumers (e.g., other AMFs, and SMF 32) via a service-based interface (i.e., Namf interface). The NF services provided by the AMF 31 include a communication service (Namf_Communication). This communication service allows NF consumers (e.g., SMF 32) to communicate with the UE 1 or the AN 2 via the AMF 31.

A Session Management Function (SMF) 32 is one of the network function nodes in the control plane of the 3GPP core network 3. The SMF 32 manages PDU Sessions. The SMF 32 sends and receives SM signaling messages (NAS-SM messages, N1 SM messages) to and from the Non-Access-Stratum (NAS) Session Management (SM) layer of the UE 1 via the communication service provided by the AMF 31. The SMF 32 provides Network Function (NF) services to NF consumers (e.g., AMF 31, other SMFs, and NEF 36) via a service-based interface (i.e., Nsmf interface). The NF services provided by the SMF 32 include a PDU Session management service (Nsmf_PDUSession). This NF Service allows NF consumers (e.g., AMF 31) to handle PDU Sessions. The NF service provided by the SMF 32 further includes an Event Notification service (Nsmf_EventExposure). The service operations exposed by this NF service allow NF consumers (e.g., NEF 36, AF 5) to get notified of events that occur in PDU Sessions.

The User Plane Function (UPF) 33 is one of the network function nodes in the user plane of the 3GPP core network 3. The UPF 33 processes and forwards user data. The functionality of the UPF 33 is controlled by the SMF 32. The UPF 33 may include multiple UPFs (e.g., two UPFs 33 shown in FIG. 1) interconnected via the N9 interface. The UP path (or route) for one PDU Session of the UE 1 may include one or more PDU Session Anchor (PSA) UPFs, may include one or more Intermediate UPFs (I-UPFs), and may include one or more Uplink Classifier (UL CL) UPFs (or Branching Point (BP) UPFs). The UP Path for a PDU Session is a path set up within 3GPP Core Network 3 to route user plane data (e.g., Internet Protocol (IP) packets) for that PDU Session from the UE 1 to a DN (e.g., LADN 41, LADN 42, or DN 43) and vice versa. A UP path contains at least one UPF 33 and includes an N6 interface with a DN. A UP path may contain one or more N9 tunnels. An N9 tunnel is a tunnel between two UPFs 33.

A Policy Control Function (PCF) 34 is one of the network function nodes in the control plane of the 3GPP core network 3. The PCF 34 supports interactions with the access and mobility policy enforcement within the AMF 31 via a service-based interface (i.e., Npcf interface). The PCF 34 provides access and mobility management-related policies to the AMF 31. In addition, the PCF 34 provides session-related policies to the SMF 32. The session-related policies include PDU Session-related policy information and Policy and Charging Control (PCC) rule information. The PCC rule information includes control information regarding AF influence on traffic routing (i.e., AF influenced Traffic Steering Enforcement Control information).

A Unified Data Management (UDM) 35 is one of the network function nodes in the control plane of the 3GPP core network 3. The UDM 35 provides access to a database (i.e., User Data Repository (UDR)) storing subscriber data (or subscription information). The UDM 35 provides NF services to NF consumers (e.g., AMF 31, SMF 32) via a service-based interface (i.e., Nudm interface). The NF services provided by the UDM 35 include a subscriber data management service. This NF service allows NF consumers (e.g., AMF 31, PCF 34) to retrieve subscriber data and provides updated subscriber data to the NF consumers. From a subscriber data management perspective, the UDM 35 can be represented as a UDR. Similarly, a UDR may be represented as a UDM 35.

A Network Exposure Function (NEF) 36 is one of the network function nodes in the control plane of the 3GPP core network 3. The NEF 36 has a role similar to that of a Service Capability Exposure Function (SCEF) in the Evolved Packet System (EPS). Specifically, the NEF 36 supports the exposure of services and capabilities from the 3GPP system to applications and network functions inside and outside the operator network. The NEF 36 provides NF services to NF consumers (e.g., AF 5) via a service-based interface (i.e., Nnef interface). The NF services provided by the NEF 36 include an event notification service (Nnef_EventExposure). The service operations exposed by this NF service allow NF consumers (e.g., AF 5) to get notified of events occurring in the 3GPP system. The NF services provided by the NEF 36 also include a service for Application Function influence on traffic routing (Nnef_TrafficInfluence). The service operations exposed by this NF service allow NF consumers (e.g., AF 5) to make requests to influence the traffic routing of PDU Session(s) of a particular UE.

An Application Function (AF) 5 interacts with the 3GPP core network 3. For example, the AF 5 interacts with the 3GPP core network 3 to support the Application Function influence on traffic routing. Depending on the placement of the AF 5 and the policy of the MNO, the AF 5 may interact directly with network functions within the 3GPP core network 3. Otherwise, the AF 5 interacts with network functions within the 3GPP core network 3 via the NEF 36. The AF 5 may include one or more computers. For example, the AF 5 may include one or more servers (e.g., content delivery servers, online game servers) that communicate with the UE 1 at the application layer, and a controller (i.e., an AF according to the 3GPP definition) that interfaces with these one or more servers and interacts with the 3GPP core network 3 (e.g., NEF 36, and SMF 32). The AF 5 may include multiple servers that are deployed in a distributed manner. For example, the AF 5 may include multiple edge computing servers located at (or connected to) the LADN 41 and LADN 42, in addition to a central server located at (or connected to) the DN 43. In the example in FIG. 1, the AF 5 may communicate with an application running on the processor of the UE 1 through at least one of the LADN 41, LADN 42, and DN 43.

The example configuration in FIG. 1 shows only representative NFs for illustration purposes. The radio communication network according to this embodiment may include other NFs not shown in FIG. 1, such as a Network Slice Selection Function (NSSF) and a Network Data Analysis Function (NWDAF).

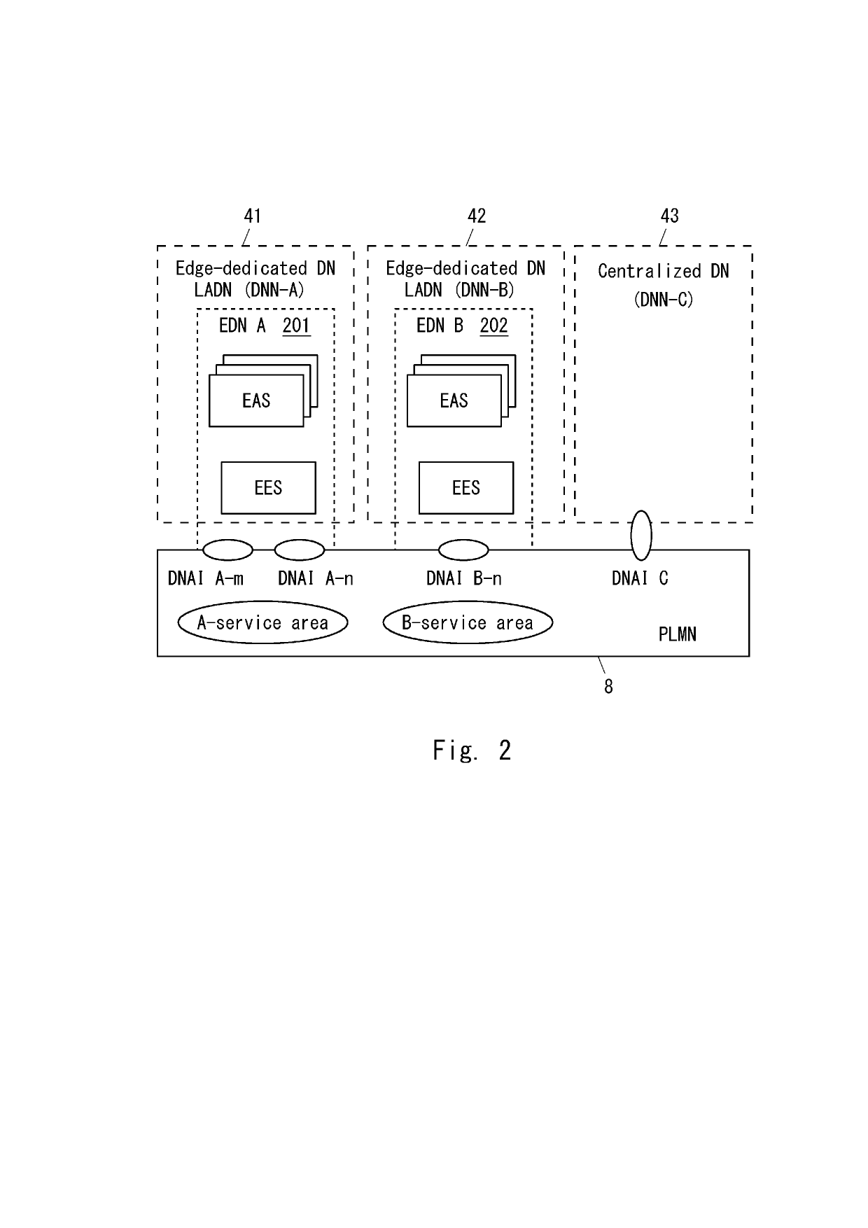

FIG. 2 shows an example of deployment models for Edge Data Networks (EDNs). A Public Land Mobile Network (PLMN) 8 includes the AN 2 and the 3GPP core network 3. In the example in FIG. 2, EDN A (201) and EDN B (202) are edge-dedicated data networks deployed as LADNs. Specifically, the LADN 41 includes the EDN A (201), while the LADN 42 includes the EDN B (202). The service area of the EDN A1 (201) is the same as the LADN service area of the LADN 41. The service area of the EDN A2 (202) is the same as the LADN service area of the LADN 42. The service area of the EES within the EDN A (201) is the same as or a subset of the EDN service area (i.e., the LADN service area of the LADN 41). The service area of an individual EAS within the EDN A (201) is identical to or a subset of the service area of the corresponding EES. Similarly, the service area of the EES within the EDN B (202) is identical to or a subset of the EDN service area (i.e., the LADN service area of the LADN 42). The service area of an individual EAS within the EDN B (202) is equal to or a subset of the service area of the corresponding EES.

As shown in FIG. 2, user plane accesses to the LADN 41, LADN 42, and DN 43 may be distinguished by DN Access Identifiers (DNAIs). A DNAI is an identifier of user plane access to one or more DNs where an application is deployed.

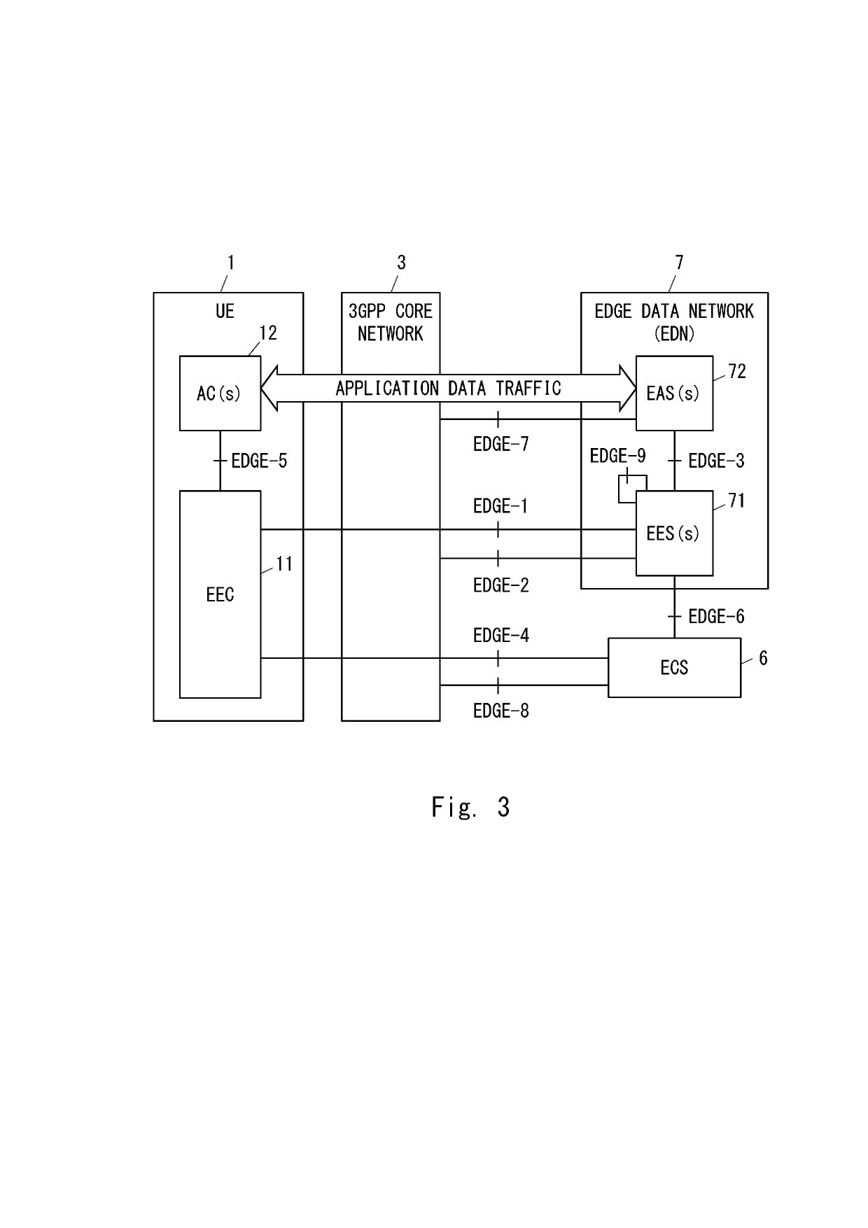

FIG. 3 shows an example of the 3GPP EDGEAPP architecture according to this example embodiment. Each of the elements shown in FIG. 3 is a functional entity, providing functions and interfaces as defined by the 3GPP. Each of the elements (functional entities) shown in FIG. 1 can be implemented, for example, as a network element on dedicated hardware, as a software instance running on dedicated hardware, or as a virtualized function instantiated on an application platform.

In the example in FIG. 3, the UE 1 includes an Edge Enabler Client (EEC) 11 and one or more Application Clients (ACs) 12. In other words, an EEC 11 and one or more ACs 12 are deployed in the UE 1 and run on the UE 1. Although not explicitly shown in FIG. 3, the UE 1 communicates with the 3GPP core network 3 (e.g., 5GC) via the AN 2. In this way, the UE 1 provides the EEC 11 and AC(s) 12 with connectivity to a data network via the AN2 and the 3GPP core network 3.

The EEC 11 provides supporting functions required by the AC(s) 12. Specifically, the EEC 11 provides provisioning of configuration information to enable the exchange of application data traffic with an Edge Application Server (EAS). In addition, the EEC 11 provides functions for a discovery of one or more EASs available within an EDN 7. The EEC 11 uses EAS endpoint information obtained from the EAS discovery in routing of outgoing application data traffic to an EAS. Further, the EEC 11 provides functions for registration (i.e., registration, update, and de-registration) of an EES 71 and EAS(s) 72.

Each AC 12 is an application running on the UE 1. Each AC 12 connects to one or more EASs to utilize edge computing services and exchanges application data traffic with these EASs.

One EDN 7 includes one or more EESs 71 and one or more EASs 72. As already explained, the EDN 7 may be a LADN. For example, the EDN 7 shown in FIG. 3 may be an edge-dedicated data network deployed as the LADN 41 or 42 shown in FIGS. 1 and 2. The EESs 71 and EASs 72 may be included in the AF 5 shown in FIG. 1.

Each EES 71 provides supporting functions required by an EAS(s) 72 and the EEC 11. Specifically, each EES 71 provides the EEC 11 with the provisioning of configuration information, thereby enabling the exchange of application data traffic with an EAS(s) 72. Each EES 71 provides functions for registration (i.e., registration, update, and de-registration) of the EEC 11 and EAS(s) 72. Each EES 71 provides functions of application context transfer between EESs. These functions are required for application context relocation (or edge application mobility) for service continuity. The application context is the set of data present in an EAS and related to an AC. Application context relocation involves transferring the application context regarding the user (i.e., AC) from a source EAS (or old EDN or old LADN) to a target EAS (or new EDN or new LADN). Application context relocation is triggered by UE mobility events or non-UE mobility events. UE mobility events include, for example, intra-EDN mobility, inter-EDN mobility, and Local Area Data Network (LADN)-related mobility. Non-UE mobility events include, for example, EAS or EDN overload conditions and EAS maintenance (e.g., graceful shutdown of the EAS).

Further, each EES 71 supports the functionality of the Application Programming Interface (API) invoker and the API exposing function. Each EES 71 provides ACR management event notifications functionality to the EAS(s) 72. The ACR management event notifications functionality is the ability to notify EASs of UE mobility events or non-UE mobility events for one or more UEs that trigger Application Context Relocation (ACR) procedures. The types of events (event IDs) include user plane path change detection (i.e., "User plane path change"); user plane path change detection and T-EAS identification (i.e., "ACR monitoring"); user plane path change and T-EAS identification and traffic change appropriate for the T-EAS (i.e., "ACR facilitation"); and whether a UE has moved into or out of a particular location or area (i.e., "Presence-In-Area of Interest (AOI)-Report"). The EAS(s) 72 subscribe in advance to these events provided by the EES 71 in order to receive notifications they seek. The " particular location or area" may be a Tracking Area Identity (TAI) list or Cell IDs, or it may be a TAI list associated with a particular LADN. Each EES 71 may interact with the 3GPP core network 3 directly (e.g., via PCF 34) or indirectly (e.g., via NEF 36 or Service Capability Exposure Function (SCEF)) to access services and capabilities of network functions within 3GPP core network 3. Each EES 71 may support external exposure of services and capabilities of 3GPP network functions to the EAS(s) 72. Each EES 71 may support the Application Function influence on traffic routing and may interact with the 3GPP core network 3.

Each EAS 72 is located in the EDN 7 and performs server functions of an application. The server functions of an application may be available only at the edge. In other words, the server functions of an application may be available only as an EAS. However, the server functions of an application may be available both at the edge and in the cloud. In other words, the server functions of an application may be available as an EAS and in addition may be available as an application server in the cloud. The term "cloud" here means a central cloud (e.g., DN 43 in FIGS. 1 and 2) located further away from the UE 1 than the EDN 7(e.g., LADN 41 or 42 in FIGS. 1 and 2). Accordingly, an application server in the cloud means a server deployed in a centralized location (e.g., a centralized data center). Each EAS 72 may consume or utilize 3GPP core network capabilities. Each EAS 72 may directly invoke 3GPP Core Network function APIs. Alternatively, each EAS 72 may consume or utilize 3GPP core network capabilities via the EES 71, or via the NEF 36 or SCEF. Each EAS 72 may support Application Function influence on traffic routing and interact with the 3GPP core network 3.

An Edge Configuration Server (ECS) 6 provides supporting functions required by the EEC 11 to connect to the EES(s) 71. Specifically, the ECS 6 provides provisioning of edge configuration information to the EEC 11. The edge configuration information includes information to the EEC 11 for connecting to the EES(s) 71 (e.g., service area information applicable to the LADN) and for establishing a connection to the EES(s) 71 (e.g., Uniform Resource Identifier (URI)). The ECS 6 provides the functionality for registration (i.e., registration, update, and de-registration) of the EES(s) 71. Further, the ECS 6 supports the functionality of the API invoker and the API exposing function. The ECS 6 may interact directly (e.g., via PCF 34) or indirectly (e.g., via NEF 36 or SCEF) with the 3GPP Core Network 3 to access the services and capabilities of the network functions in the 3GPP Core Network 3. The ECS 6 may be located in the MNO domain providing the 3GPP core network 3 or in a third party domain of a service provider (e.g., Edge Computing Service Provider (ECSP)). The ECS 6 may be located in a central cloud (e.g., DN 43 in FIGS. 1 and 2). The ECS 6 may be included in the AF 5 shown in FIG. 1.

The example configuration in FIG. 3 shows only representative elements for illustrative purposes. For example, the ECS 6 may be connected to multiple EDNs.

The operation of the SMF 32 according to this example embodiment is described below. If the UE 1 has moved out of an EDN service area or out of an LADN service area, the SMF 32 will not immediately release a PDU session for that EDN or LADN or deactivate a UP connection for that PDU session, but will do so after a period of time. Specifically, the SMF 32 releases the PDU Session for that EDN or LADN or deactivates the UP connection for that PDU Session in response to detecting an event related to an ACR procedure. The SMF 32 may detect an event related to the ACR procedure after receiving a first event notification from the AMF 31 indicating that the UE 1 is outside the EDN service area or outside the LADN service area.

The event related to the ACR procedure may be an event indicating that the AF 5 has successfully completed the ACR procedure. The event related to the ACR procedure may be an event that allows the AF 5 to successfully complete the ACR procedure. The event related to the ACR procedure may be the receipt or detection of the receipt of a response from the AF 5 indicating that it has successfully completed the ACR procedure. In this case, the SMF 32 may send an event notification (called a second event notification) to the AF 5 and wait for a response from the AF 5. The second event notification may be a notification indicating that the UE 1 is out of the EDN service area or out of the LADN service area, or it may be a prior notification of the release of a PDU Session for the EDN, a prior notification of the release of a PDU Session for the LADN, or a prior notification of the deactivation of a UP connection. The response from the AF 5 indicating successful completion of the ACR procedure may be a response to the second event notification. The successful completion of the ACR procedure may include the transfer of application context from the Source Edge Application Server (S-EAS) to the Target EAS (T-EAS).

Alternatively, the event related to the ACR procedure may be that the SMF 32 receives a message from the PCF 34 instructing it to initiate a procedure for releasing the PDU Session for that EDN or LADN or a procedure for deactivating the UP connection for that PDU Session. In this case, the PCF 34 may decide to send this message based on information provided by the AF 5 (e.g., S-EES) to the PCF 34 via the NEF 36 and the UDM 35.

Alternatively, the event related to the ACR procedure may be the elapse (or expiration) of a predetermined grace period to wait for the AF 5 to complete the ACR procedure. In this case, if the UE 1 has moved out of the EDN service area or out of the LADN service area, the SMF 32 waits for the grace period to expire before initiating the release of the PDU Session or the deactivation of the UP connection for that EDN or that LADN. The deactivation of a UP connection is the release of the data radio bearer in the (Radio) Access Network ((R)AN) 2 and the N3 tunnel between the (R)AN 2 and the UPF 33, which constitute the UP connection. Similarly, the activation of a UP connection means the establishment (or configuration) of the data radio bearer of the (Radio) Access Network ((R)AN) 2 and the N3 tunnel between the (R)AN 2 and the UPF 33, which constitute the UP connection.

The SMF 32 may only perform this action for specific EDNs, specific LADNs (LADN DNNs), specific PDU Sessions, or specific UEs. If the UE 1 has moved out of the LADN service area and the LADN belongs to specific LADNs, then the SMF 32 may wait for a grace period to expire before initiating the release of a PDU Session or deactivation of a UP connection for that LADN. Similarly, if the UE 1 has moved out of the EDN service area and the EDN belongs to specific EDNs, then the SMF 32 may wait for a grace period to expire before initiating the release of a PDU Session or deactivation of a UP connection for that EDN.

Specific LADNs may be defined by their LADN type. Specific LADNs may be distinguished from other LADNs by their LADN DNN. Specific EDNs may be defined by their EDN type. Specific EDNs may be distinguished from other EDNs by (EDN) DNN, or by (EDN) DNN and DNAI, or by network slice information, or by (EDN) DNN and network slice information. The network slice information may be Single Network Slice Selection Assistance Information (S-NSSAI). In particular, a PDU Session for a specific EDN may be associated with a specific network slice (or specific S-NSSAI). In this case, a specific EDN may be identified by DNN and network slice information (e.g., S-NSSAI).

The fact that the UE 1 is outside of an EDN service area may mean that the UE 1 is outside of an EES service area or outside of an EAS service area. In other words, in the terminology used herein, an EDN service area may be the same as an EES service area or an EAS service area. An EES service area is a service area provided by an EES within an EDN. An EAS service area is a service area provided by an EAS within an EDN. An EES service area may be a topological or geographic service area. Similarly, an EAS service area may be a topological or geographic service area. A topological service area is defined in relation to a UE's point of connection to the network. A topological service area may be defined by a set of Cell IDs, a set of TAIs, or a PLMN ID. A geographic service area may be an area defined by geographical coordinates, a circle whose center is denoted by geographical coordinates, or an area defined as a polygon whose corners are denoted by geographical coordinates. Geographic service area can be represented in other ways, such as well-known buildings, parks, arenas, civic addresses, zip codes, and so on.

The SMF 32 may be preconfigured with specific LADNs or specific EDNs by the MNO. The SMF 32 may obtain a configuration indicating specific LADNs or specific EDNs from the AMF 31 or the UDM 35. For example, specific LADNs may be LADNs for EDNs. The specific LADNs or specific EDNs may be managed in the UDM 35 as subscription information about the UE 1. In that case, the information about specific LADNs or specific EDNs may be transferred from the UDM 35 to the AMF 31 through the Nudm_SDM_Get service during the location registration procedure for the UE 1. Then, when the UE 1 establishes a PDU Session for that LADN (PDU Session Establishment procedure), the SMF 32 may be informed of the information about specific LADNs or specific EDNs by the AMF 31 via the Nsmf_PDUSession_CreateSMContext Request message or the Nsmf_PDUSession_UpdateSMContext Request message. Alternatively, the SMF 32 may receive the information about specific LADNs or specific EDNs from the UDM 35 using the Nudm_SDM_Get service when, for example, the UE 1 establishes a PDU Session for the LADN or EDN. Alternatively, the information about specific LADNs or specific EDNs may be UE local configuration information as specified by Non-Patent Literature 4. In that case, the information about specific LADNs or specific EDNs may be sent from the UE 1 to the SMF 32 via the AMF 31 using a NAS message (or NAS SM message).

The SMF 32 may distinguish a particular PDU Session based on a request from the AF 5 via the NEF 36. Specifically, if the SMF 32 has received information from the AF 5 in advance indicating that it needs to wait for a response from the AF 5 before releasing a PDU Session or initiating the deactivation of a UP connection, the SMF 32 send an event notification to the AF 5 and wait for a response from the AF 5 before releasing that PDU Session or deactivating that UP connection.

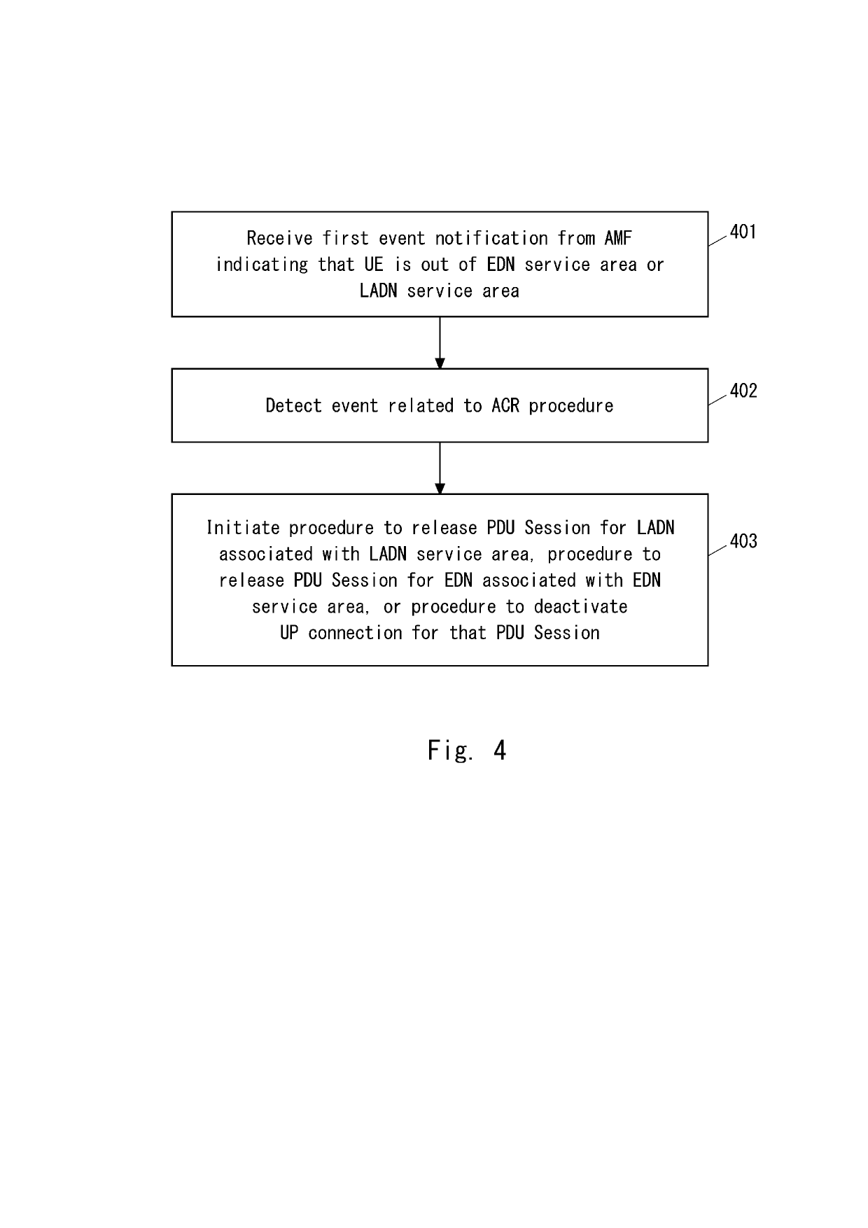

FIG. 4 is a flowchart showing an example of the operation of the SMF 32 according to this example embodiment. In step 401, the SMF 32 receives a first event notification from the AMF 31 indicating that the UE 1 is outside an EDN service area or LADN service area. In step 402, after receiving the first event notification, the SMF 32 detects an event related to an Application Context Relocation (ACR) procedure. In step 403, in response to detecting the event related to the ACR procedure, the SMF 32 initiates a procedure to release a PDU Session for an LADN associated with that LADN service area, a procedure to release a PDU Session for (or associated with) an EDN associated with that EDN service area, or a procedure to deactivate a UP connection for that PDU Session. In other words, after the SMF 32 receives a first event notification indicating that the UE 1 is out of the service area of an EDN or LADN, the SMF 32 waits for an event related to an ACR procedure before releasing the PDU Session or deactivating the UP connection for that EDN or LADN. As previously explained, the SMF 32 may only perform the operation of FIG. 4 with respect to specific EDNs, specific LADNs, specific PDU Sessions, or specific UEs.

The event related to the ACR procedure may involve receiving a response from the AF 5 directly or through the NEF 36 after sending a second event notification from the SMF 32 to the AF 5 directly or through the NEF 36. If the SMF 32 has previously received information from the AF 5 indicating that the SMF 32 should wait for a response from the AF 5 before releasing a PDU Session or initiating the deactivation of a UP connection, then the SMF 32 may send a second event notification to the AF 5 and wait for a response from the AF 5 before releasing that PDU Session or deactivating that UP connection. For example, the information to wait for a response from the AF 5 before initiating the release of a PDU Session or the deactivation of a UP connection may be an indication of "AF acknowledgement to be expected".

In one example, if the SMF 32 has previously received an AF request, which is a request to subscribe to a service for providing a second event notification for a PDU Session, either directly from the AF 5 or via NEF 36, and the request contains an indication of "AF acknowledgement to be expected", then the SMF 32 may send a second event notification to the AF 5 and wait for a response from the AF 5 before releasing that PDU Session or deactivating that UP connection. In other words, the SMF 32 manages the timing of PDU Session release based on runtime coordination between the 5GC and the EDGEAPP using the "AF acknowledgement to be expected". The second event notification may indicate that the UE 1 is outside the EDN service area or outside the LADN service area. The second event notification may indicate a prior notification of the release of the PDU Session for the EDN or LADN or a prior notification of the deactivation of the UP connection. The response from the AF 5 may indicate the completion of the ACR procedure, including the transfer of an application context from an S-EAS to a T-EAS.

Alternatively, the event related to the ACR procedure may include the expiration (or elapse) of a predetermined amount of time to wait for the completion of that ACR procedure. The SMF 32 may start a timer to count the predetermined amount of time after receiving the first event notification from the AMF 31 indicating that the UE 1 is outside the EDN service area or the LADN service area. The SMF 32 may determine whether the initiation of the timer is required based on the DNN or the LADN or the EDN. The SMF 32 may determine whether the initiation of the timer is required based on the type of the DNN or LADN or EDN. The SMF 32 may determine whether the timer needs to be started based on whether the DNN or LADN or EDN is associated with the timer. The SMF 32 may determine the enforcement of the PDU Session release procedure or the UP connection deactivation procedure based on the detection of the event related to the ACR procedure.

Alternatively, the event related to the ACR procedure may include the receipt by the SMF 32 of a notification or message regarding the procedure specified in Section 4.3.6.2 of Non-Patent Literature 4. Specifically, in response to the Npcf_SMPolicyControl_UpdateNotify service received from the PCF 34, the SMF 32 may initiate a procedure to release the PDU Session for that EDN or LADN or deactivate the UP connection for that PDU Session. In other words, the Npcf_SMPolicyControl_UpdateNotify service invoked by the PCF 34 instructs the SMF 32 to perform the procedure to release the PDU Session for that EDN or LADN or to deactivate the UP connection for that PDU Session. The PCF 34 may decide to send this instruction based on information provided by the AF 5 (e.g., S-EES) to the PCF 34 via the NEF 36 and the UDM 35. The AF 5 (e.g., S-EES) may detect that the UE 1 is outside the EDN service area or outside the LADN service area using the Location Reporting functionality specified in Non-Patent Literature 4, Section 4.15.3.1. In response to this detection, the AF 5 (e.g., S-EES) may then instruct the 3GPP core network 3 to release the PDU Session of the relevant EDN or LADN or deactivate the UP connection for the relevant PDU Session.

According to the operations described above, if the UE 1 has moved out of an EDN service area or LADN service area, the SMF 32 can wait for a grace period to expire before initiating the release of a PDU Session or the deactivation of a UP connection for the relevant EDN or LADN. This can help prevent failed ACR procedures when the UE 1 moves between different LADNs or different EDNs. Specifically, after the UE 1 moves out of the EDN service area or out of the LADN service area, the PDU Session for the old EDN or old LADN is maintained for a period of time (e.g., until an event related to the ACR procedure is detected). For example, the SMF 32 maintains the PDU Session for the old EDN or old LADN until it can guarantee that the ACR procedure will be completed successfully, until it presumes that the ACR procedure will be completed successfully, or until it has confirmed that the ACR procedure has been completed successfully. Accordingly, the UE 1 can communicate with the EES (i.e., S-EES) of the old EDN or old LADN via this PDU Session. This may increase the likelihood of successful completion of the ACR procedure involving signaling between the S-EES and the EEC 11 of the UE 1.

In this example embodiment, EDN service area management based on network slices may be used. Specifically, an EDN or an EES or EAS within an EDN may be associated with a particular network slice. In other words, only if the UE 1 is authorized to use a particular network slice, the UE 1 may be able to access an EDN (or EES or EAS) associated with that network slice. The particular network slice may be available in throughout the PLMN or only in some topological areas within the PLMN. The topological areas may be one or more TAs (or TAIs). If the particular network slice is only available in one or more TAs, the registration area of the UE 1 that has established a PDU Session to access an EAS in that EDN is the same as, or a subset of, the one or more TAs (or TAIs) assigned to the particular network slice. In this case, the EDN service area is the same as, or a subset of, the one or more TAs (or TAIs) assigned to the particular network slice. In addition, step 401 in FIG. 4 is an indication of the release of a PDU Session or the deactivation of a UP connection due to the fact that the UE 1 has moved out of the topological area (e.g., one or more TAs) assigned to that particular network slice (or particular S-NSSAI). Consider specifically the case where the UE 1 has been informed by the 3GPP core network 3 (i.e., AMF 31) of Allowed NSSAI containing a certain S-NSSAI and there are one or more PDU Sessions of the UE 1 associated with that S-NSSAI. In this case, if the UE 1 has moved out of the topological area assigned to this S-NSSAI (or the current registration area of the UE 1), then in step 401 of FIG. 4, the AMF 31 notifies the UE 1 of this S-NSSAI as a Rejected S-NSSAI and also instructs the SMF 32 to release the PDU Session(s) associated with this S-NSSAI.

In the case of the EDN service area management based on network slices, the behavior of the SMF 32 in step 402 of FIG. 4 is similar to that described above. In step 403 of FIG. 4, in response to the detection of the event related to the ACR procedure in step 402, the SMF 32 releases the PDU Session(s) of the UE 1 associated with the S-NSSAI that has become a Rejected S-NSSAI.

According to these operations, if the UE 1 has moved out of an EDN service area, the SMF 32 can wait for a grace period to expire before initiating the release of a PDU Session or the deactivation of a UP connection for the relevant EDN. This can help prevent failed ACR procedures when the UE 1 moves between different EDNs. Specifically, after the UE 1 moves out of the EDN service area, the PDU Session for the old EDN is maintained for a period of time (e.g., until an event related to the ACR procedure is detected). For example, the SMF 32 maintains the PDU Session for the old EDN until it can guarantee that the ACR procedure will be completed successfully, until it presumes that the ACR procedure will be completed successfully, or until it has confirmed that the ACR procedure has been completed successfully. Accordingly, the UE 1 can communicate with the EES (i.e., S-EES) of the old EDN via this PDU Session. This may increase the likelihood of successful completion of the ACR procedure involving signaling between the S-EES and the EEC 11 of the UE 1.

### Second Example Embodiment

This example embodiment provides detailed examples of the operation of the SMF 32 described in the first example embodiment and examples of the operation of the AMF 31, NEF 36, and AF 5 that are useful for this purpose. The example network architecture according to this example embodiment is similar to the examples described with reference to FIGS. 1 through 3.

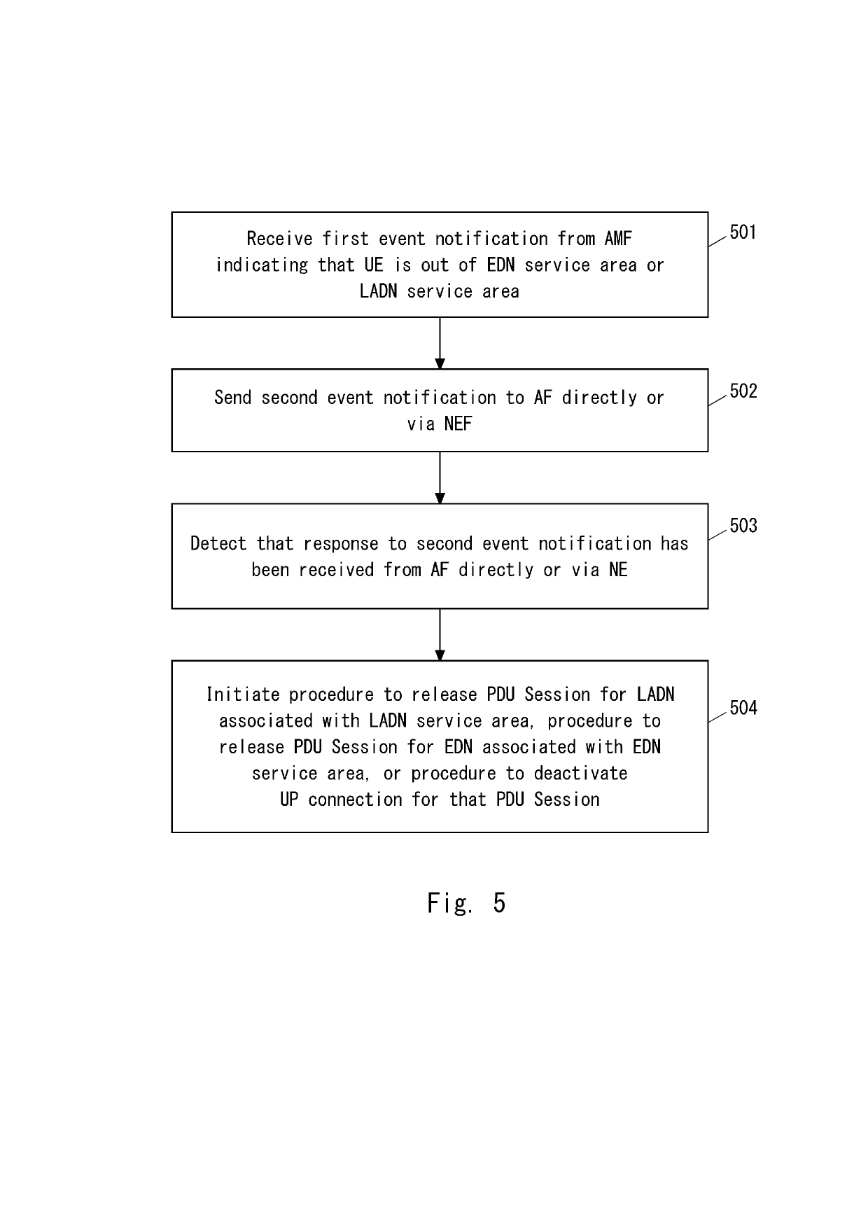

FIG. 5 is a flowchart showing an example of how the SMF 32 operates. Step 501 is similar to step 401 in FIG. 4. Specifically, in step 501, the SMF 32 receives a first event notification from the AMF 31 indicating that the UE 1 is outside an EDN service area or an LADN service area. Steps 502 and 503 are an example of step 402 in FIG. 4. In step 502, the SMF 32 sends a second event notification to the AF 5 (e.g., S-EES) directly or via the NEF 36. In step 503, the SMF 32 detects that a response to the second event notification has been received from the AF 5 directly or via the NEF 36. In step 504, after detecting that the response to the second event notification has been received, the SMF 32 initiates a procedure for releasing a PDU Session for an LADN associated with the relevant LADN service area, a procedure for releasing a PDU Session for an EDN associated with the relevant EDN service area, or a procedure for deactivating a UP connection for that PDU Session.

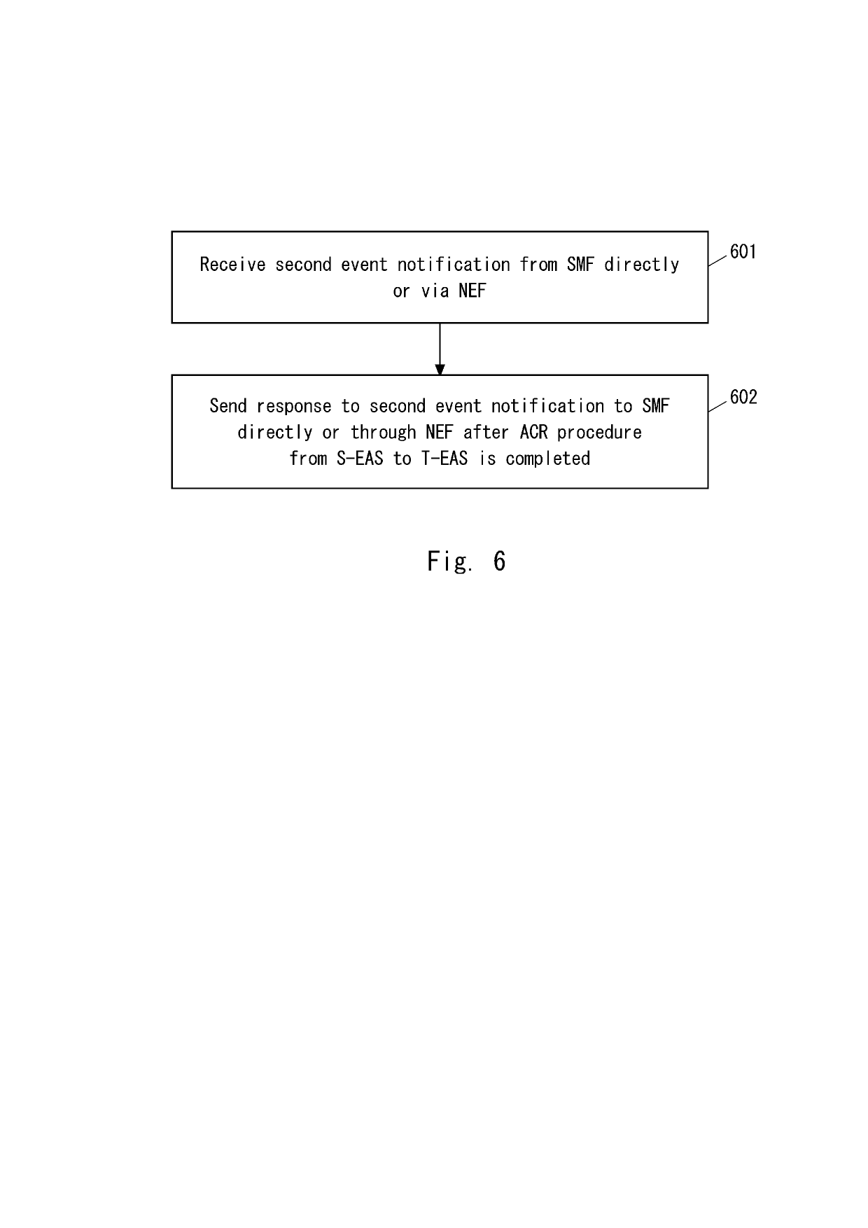

FIG. 6 shows a flowchart of an example of how the AF 5 (e.g., S-EES) operates. In step 601, the AF 5 receives a second event notification from the SMF 32 directly or via the NEF 36. In step 602, the AF 5 sends a response to the second event notification to the SMF 32 directly or through the NEF 36 after an ACR procedure from an S-EAS to a T-EAS is completed. The response may trigger the SMF 32 to release a PDU Session for an EDN or LADN or to deactivate a UP connection.

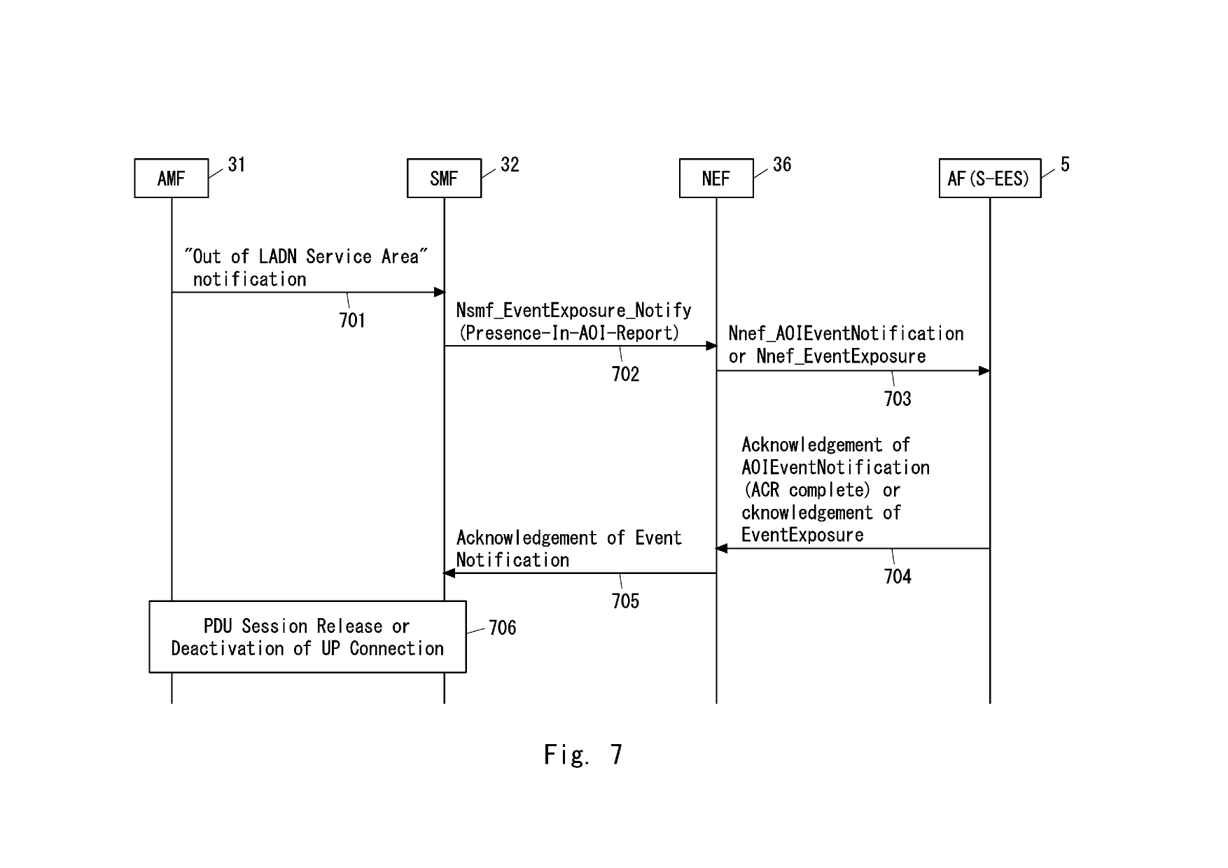

FIG. 7 is a sequence diagram showing an example of the operation of the AMF 31, SMF 32, NEF 36, and AF 5. The AF 5 may include an S-EES. In step 701, the AMF 31 sends an event notification to the SMF 32 indicating that the UE 1 is outside an EDN service area or outside an LADN service area. To receive this event notification, the SMF 32 may subscribe in advance to the UE mobility event notifications provided by the AMF 31 using the event ID "UE moving in or out of Area of Interest". This allows the SMF 32 to get notified about the event ID.

In steps 702 and 703, the SMF 32 sends an event notification to the AF 5 through the NEF 36, explicitly or implicitly indicating that the UE 1 is outside the EDN service area or the LADN service area. Specifically, in step 702, in response to detecting an event (e.g., "Presence-In-AOI-Report") subscribed to by the NF consumer (i.e., AF 5 or NEF 36), the SMF 32 invokes the Nsmf_EventExposure_Notify service operation to report this event to the NEF 36 or the AF 5. In step 703, the NEF 36 calls a service operation to report this event to the AF 5. The service operation called by the NEF 36 may be a modification of an existing service operation (e.g., Nnef_EventExposure) or a newly defined service operation (e.g., Nnef_AOIEventNotification).

In steps 704 and 705, the AF 5 sends a response to the SMF 32 via the NEF 36. Specifically, in step 704, the AF 5 sends to the NEF 36 a response (Acknowledgement of AOIEventNotification or Acknowledgement of EventExposure) to the event notification in step 703. This response may indicate the completion of an ACR procedure involving the transfer of application context from an S-EAS to a T-EAS (e.g., "ACR complete"). In step 705, the NEF 36 sends a response to the event notification of step 702 (Acknowledgement of Event Notification) to the SMF 32.

In step 706, after receiving the response in step 705, the SMF 32 releases a PDU Session or deactivates a UP connection for the relevant EDN or LADN. Although not illustrated, the procedure for releasing the PDU Session or deactivating the UP connection involves signaling between the SMF 32 and the UPF 33, as well as signaling between the SMF 32 and the UE 1 via the AMF 31. The procedure for releasing the PDU Session or deactivating the UP connection may be similar to the procedure specified in Non-Patent Literature 2, Section 4.3.4.2 or Section 4.3.7.

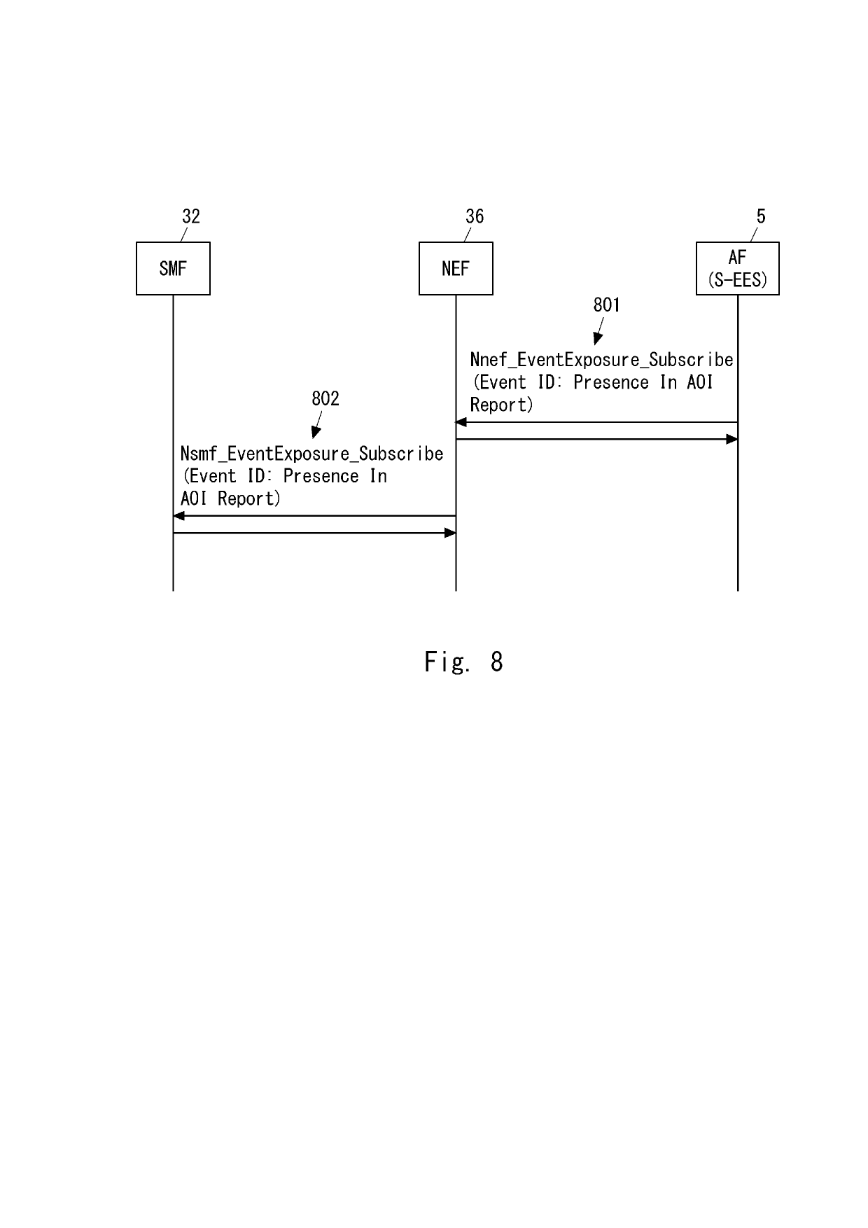

In order to receive the event notification in step 705, the AF 5 may subscribe in advance to the notification service for that event. FIG. 8 shows an example of the procedure for subscribing to the event notification service provided by the SMF 32. In step 801, the AF 5 sends an AF request to the NEF 36 to subscribe to the service for providing event notifications about a particular PDU Session. The AF request includes an indication of "AF acknowledgement to be expected". The AF 5 may invoke the Nnef_EventExposure_Subscribe operation using the event ID "Presence In AOI Report". The NEF 36 provides the UE mobility out of an Area of Interest feature so that the AF 5 can detect the movement of UEs as monitoring events. This allows the AF 5 to detect UE 1 movement events via the NEF 36 (Nnef_EventExposure_Subscribe).

In step 802, the NEF 36 requests subscription to the event notification service of the SMF 32 based on the AF request of step 801. The request includes an indication of "AF acknowledgement to be expected". In step 802, NEF 36 may invoke the Nsmf_EventExposure_Subscribe operation using the Event ID "Presence In AOI Report". Based on the fact that the received request contains the indication "AF Acknowledgement Expected", the SMF 32 understands that it needs to send an event notification to the AF 5 and wait for a response from the AF 5 before releasing the PDU Session or deactivating the UP connection. The SMF 32 provides the UE mobility out of an Area of Interest feature so that the NEF 36, or the AF 5 via the NEF 36, can detect the movement of UEs. This allows the NEF 36, or the AF 5 via the NEF 36, to receive notification (Nsmf_EventExposure_Notify) from the SMF 32 of UE 1 movement events.

According to the example described in this example embodiment, if the UE 1 has moved out of an EDN service area or out of a LADN service area, the SMF 32 sends an event notification to the AF 5 and waits for a response from the AF 5 before initiating the release of a PDU Session or the deactivation of a UP connection for the EDN or LADN. This can contribute to preventing failed ACR procedures when the UE 1 moves between different EDNs corresponding to different LADNs.

### Third Example Embodiment

This example embodiment provides detailed examples of the operation of the SMF 32 described in the first example embodiment and examples of the operation of the AMF 31, NEF 36, and AF 5 that are useful for this purpose. The example network architecture according to this example embodiment is similar to the examples described with reference to FIGS. 1 through 3.

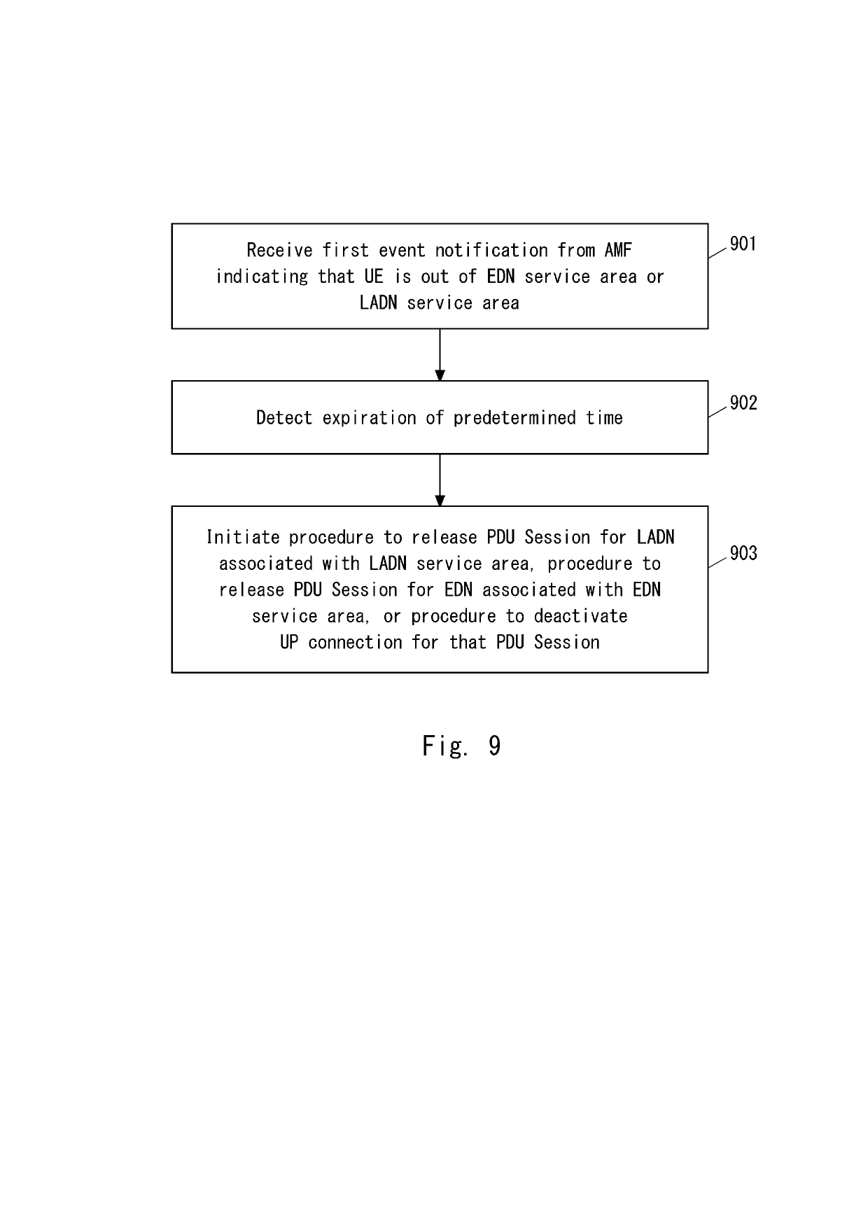

FIG. 9 is a flowchart showing an example of how the SMF 32 operates. Step 901 is similar to step 401 in FIG. 4. Specifically, in step 901, the SMF 32 receives a first event notification from the AMF 31 indicating that the UE 1 is outside an EDN service area or an LADN service area. In step 902, the SMF 32 detects the expiration of a predetermined time for waiting for an ACR procedure to complete. The SMF 32 may start a timer to count the predetermined time after receiving the first event notification. In step 903, after the predetermined time has elapsed, the SMF 32 initiates a procedure to release a PDU Session for an LADN associated with that LADN service area, a procedure to release a PDU Session for an EDN associated with that EDN service area, or a procedure to deactivate a UP connection for that PDU Session. As described in the first example embodiment, the SMF 32 may determine whether or not to start the timer based on whether or not the EDN or LADN associated with the first event notification is a particular EDN or LADN.

Similar to the first example embodiment, this example embodiment may use EDN service area management based on network slices. Specifically, an EDN or an EES or EAS within an EDN may be associated with a particular network slice. In other words, only if the UE 1 is authorized to use a particular network slice, the UE 1 may be able to access an EDN (or EES or EAS) associated with that network slice. If the particular network slice is only available in one or more TAs, the registration area of the UE 1 that has established a PDU Session to access an EAS in that EDN is the same as, or a subset of, the one or more TAs (or TAIs) assigned to the particular network slice. In this case, the EDN service area is the same as, or a subset of, the one or more TAs (or TAIs) assigned to the particular network slice. In addition, step 901 in FIG. 9 is an indication of the release of a PDU Session or the deactivation of a UP connection due to the fact that the UE 1 has moved out of the topological area (e.g., one or more TAs) assigned to that particular network slice (or particular S-NSSAI). Consider specifically the case where the UE 1 has been informed by the 3GPP core network 3 (i.e., AMF 31) of Allowed NSSAI containing a certain S-NSSAI and there are one or more PDU Sessions of the UE 1 associated with that S-NSSAI. In this case, if the UE 1 has moved out of the topological area assigned to this S-NSSAI (or the current registration area of the UE 1), then in step 901 of FIG. 9, the AMF 31 notifies the UE 1 of this S-NSSAI as a Rejected S-NSSAI and also instructs the SMF 32 to release the PDU Session(s) associated with this S-NSSAI.

In the case of the EDN service area management based on network slices, the behavior of the SMF 32 in step 902 of FIG. 9 is similar to that described above. In step 903 of FIG. 9, in response to the detection of the event related to the ACR procedure in step 402, the SMF 32 releases the PDU Session(s) of the UE 1 associated with the S-NSSAI that has become a Rejected S-NSSAI.

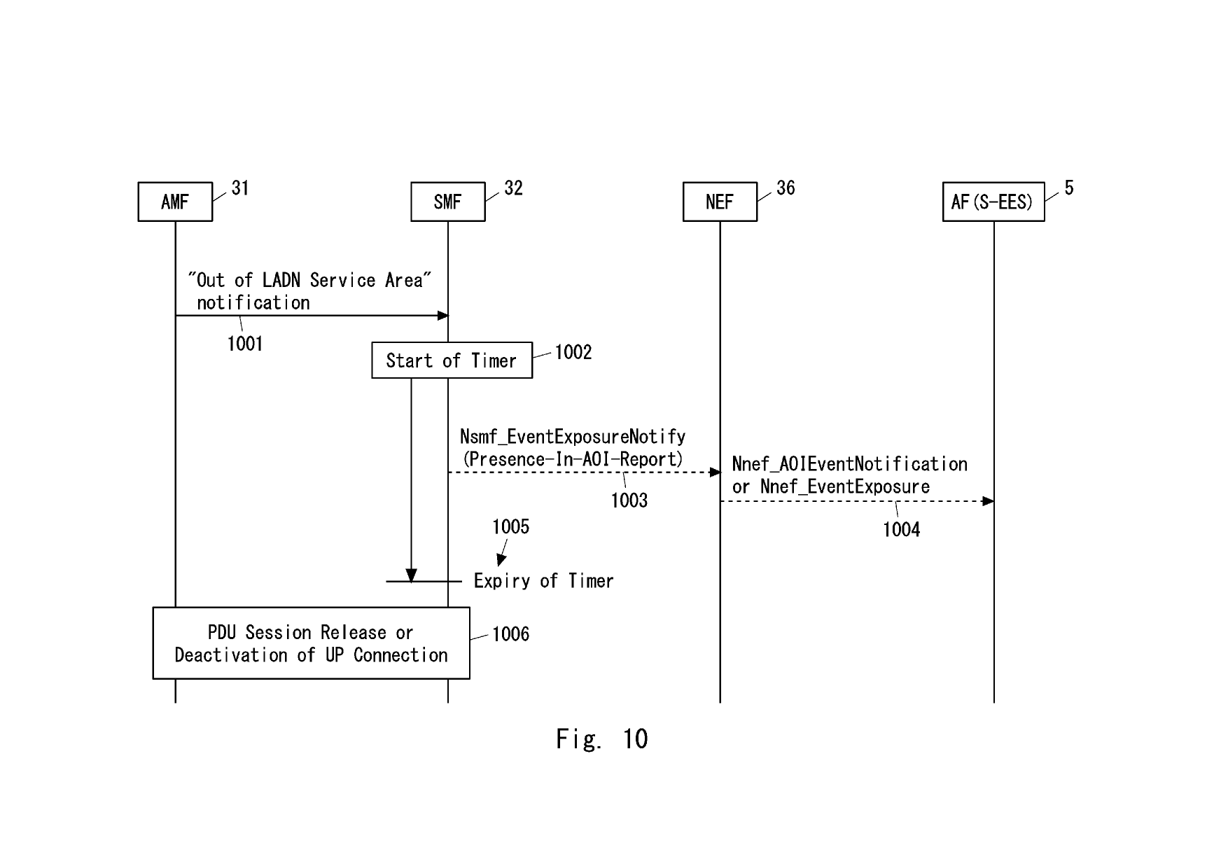

FIG. 10 is a sequence diagram showing an example of the operation of the AMF 31, SMF 32, NEF 36, and AF 5. The AF 5 may include an S-EES. In step 1001, the AMF 31 sends an event notification to the SMF 32 indicating that the UE 1 is outside an EDN service area or outside an LADN service area. To receive this event notification, the SMF 32 may subscribe in advance to the UE mobility event notifications provided by the AMF 31 using the event ID "UE moving in or out of Area of Interest". This allows the SMF 32 to get notified about the event ID.

In cases where EDN Service Area Management based on network slices is performed, in response to the UE 1 moving out of a topological area (or the current registration area of the UE 1) assigned to an S-NSSAI associated with the EDN (or EES or EAS), the AMF 31 may send the event notification of step 1001, i.e., the release instruction for the PDU Session(s) associated with the S-NSSAI. In particular, the AMF 31 may notify the SMF 32 of the release of the PDU Session(s) associated with this S-NSSAI by calling the Nsmf_PDUSession_ReleaseSMContext service operation.

In step 1002, the SMF 32 starts a timer. The value set on the timer may be determined based on local policy. The timer value may be determined based on the subscription information of the UE 1. The UE 1 may specify the timer value in a PDU Session establishment procedure. Alternatively, the AF 5 may specify the timer value. The AF 5 may indicate the timer value to the SMF 32 via the NEF 36 in a procedure for subscribing to an event notification service provided by the SMF 32.

As an example, not a limitation, in steps 1003 and 1004, the SMF 32 may send an event notification to the AF 5 via the NEF 36 that explicitly or implicitly indicates that the UE 1 is outside the EDN service area or the LADN service area. Steps 1003 and 1004 may be similar to steps 702 and 703 of FIG. 7.

In step 1005, the SMF 32 detects the expiration of the timer. In step 1006, after the timer expires, the SMF 32 releases the PDU Session for the EDN or LADN or deactivates the UP connection. Although not illustrated, the procedure for releasing the PDU Session or deactivating the UP connection involves signaling between the SMF 32 and the UPF 33, as well as signaling between the SMF 32 and the UE 1 via the AMF 31. The procedure for releasing the PDU Session or deactivating the UP connection may be similar to the procedure specified in Non-Patent Literature 2, Section 4.3.4.2 or Section 4.3.7.

According to the example described in this example embodiment, if the UE 1 has moved out of an EDN service area or out of a LADN service area, the SMF 32 waits for the expiration of a predetermined time before initiating the release of a PDU Session or the deactivation of a UP connection for the EDN or LADN. This can contribute to preventing failed ACR procedures when the UE 1 moves between different EDNs corresponding to different LADNs.

### Fourth Example Embodiment

This example embodiment provides detailed examples of the operation of the SMF 32 described in the first example embodiment and examples of the operation of the AMF 31 that are useful for this purpose. The example network architecture according to this example embodiment is similar to the examples described with reference to FIGS. 1 through 3.

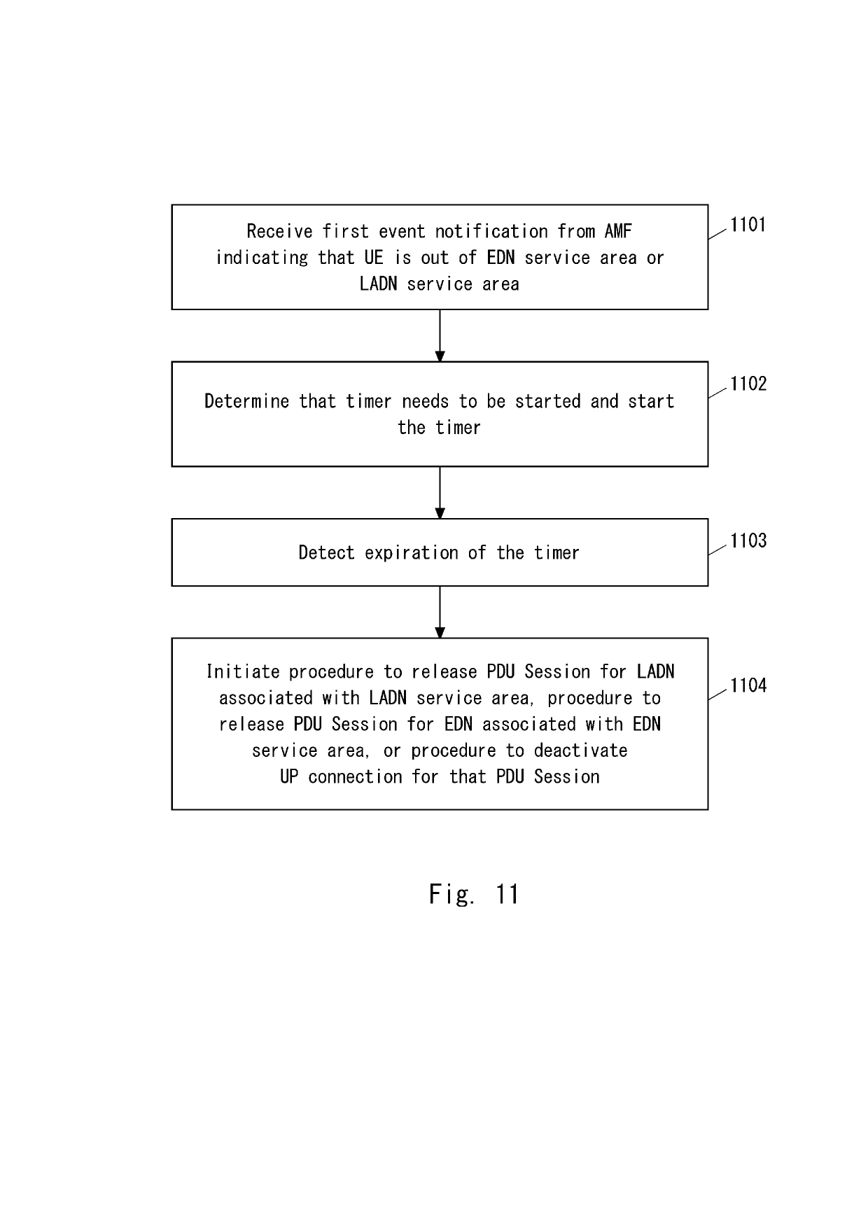

FIG. 11 is a flowchart showing an example of how the SMF 32 operates. Step 1101 is similar to step 401 in FIG. 4. Specifically, in step 1101, the SMF 32 receives a first event notification from the AMF 31 indicating that the UE 1 is outside an EDN service area or an LADN service area. In step 1102, the SMF 32 determines whether the EDN or LADN is of a specific type. The specific type of EDN or LADN may be an EDN or LADN that corresponds to (or supports) a mode for continuity of session and service. The type of LADN may be identified based on the LADN DNN. The type of EDN may be identified based on the (EDN) DNN of the EDN, or based on the (EDN) DNN and DNAI, or based on the (EDN) DNN and S-NSSAI. Further, or alternatively, the SMF 32 determines whether the LADN or EDN is associated with a timer. These determinations may be based on the LADN DNN of the LADN. These determinations may be made based on the (EDN) DNN of the EDN, based on the (EDN) DNN and DNAI, or based on the (EDN) DNN and S-NSSAI. If the EDN or LADN is of a specific type or is associated with a timer, the SMF 32 understands that the timer needs to be activated before releasing the PDU Session or deactivating the UP connection for the EDN or LADN. The SMF 32 then starts the timer. The value set for the timer may be determined based on local policy. The value of the timer may be determined based on the subscription information of the UE 1. The UE 1 may specify the value of the timer during a procedure for establishing the PDU Session.

In step 1103, the SMF 32 detects the expiration of the timer. In step 1104, after the timer expires, the SMF 32 initiates a procedure for releasing a PDU Session for an LADN associated with the LADN service area, a procedure for releasing a PDU Session for an EDN associated with the EDN service area, or deactivating a UP connection for the PDU Session.

To support the determination by the SMF 32 in step 1102, a new DNN information element "continuity of session and service capable LADN DNN" or "continuity of session and service capable EDN DNN" may be defined. In step 1102, the SMF 32 may determine whether the EDN or LADN is associated with this new DNN information element.

Note that in the example embodiments described in the present specification, the definitions of the terms "continuity of session and service" and "mode for continuity of session and service" differ from the definitions of "SSC" and "SSC mode" in the current 3GPP specifications described in Non-Patent Literature 1, Non-Patent Literature 2, and other documents. Specifically, in the current 3GPP specifications, "SSC" and "SSC mode" are used to maintain PDU Session connectivity to the same DN (or the same DNN). In particular, SSC mode 2 and mode 3 involve the establishment of a new PDU Session to the same DN (or DNN) as the old PDU Session. In contrast, in the terminology of this specification, "continuity of session and service and "mode for continuity of session and service" include the establishment of a new PDU Session service for a second DNN different from a first DNN before releasing the old PDU Session with the first DNN when the UE 1 has moved out of the LADN service area corresponding to the first DNN. In one example, the "continuity of session and service" and the "mode for continuity of session and service" include the establishment of a new PDU Session service for a second DNN to which the application context is transferred from the first DNN before releasing the old PDU Session with the first DNN when the UE 1 has moved out of the LADN service area corresponding to the first DNN.

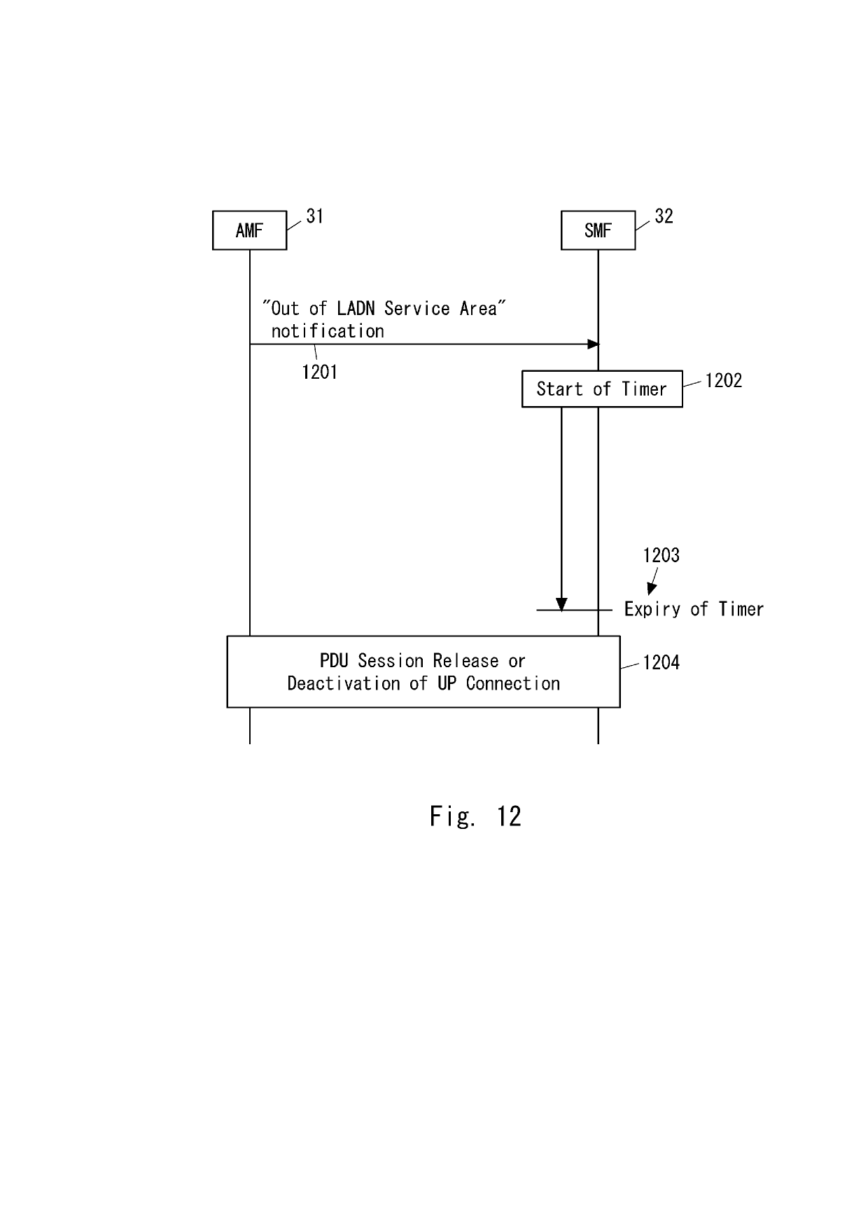

FIG. 12 is a sequence diagram showing an example of the operation of the AMF 31 and SMF 32. In step 1201, the AMF 31 sends an event notification to the SMF 32 indicating that the UE 1 is outside an EDN service area or outside an LADN service area. To receive this event notification, the SMF 32 may subscribe in advance to the UE mobility event notifications provided by the AMF 31 using the event ID "UE moving in or out of Area of Interest". This allows the SMF 32 to get notified about the event ID.

In cases where EDN Service Area Management based on network slices is performed, in response to the UE 1 moving out of a topological area (or the current registration area of the UE 1) assigned to an S-NSSAI associated with the EDN (or EES or EAS), the AMF 31 may send the event notification of step 1201, i.e., the release instruction for the PDU Session(s) associated with the S-NSSAI. In particular, the AMF 31 may notify the SMF 32 of the release of the PDU Session(s) associated with this S-NSSAI by calling the Nsmf_PDUSession_ReleaseSMContext service operation.

In step 1202, the SMF 32 determines whether the EDN or LADN is of a specific type. As described above, the specific type of EDN or LADN is, for example, but not limited to, an EDN or LADN that corresponds to (or supports) a mode for continuity of session and service. The SMF 32 may determine whether the LADN is associated with a particular DNN information element, e.g., the "continuity of session and service capable" information element. Alternatively, the SMF 32 may determine whether the EDN is associated with a particular DNN information element, for example, the "continuity of session and service capable EDN DNN" information element. If the EDN or LADN is of the specific type, then the SMF 32 recognizes that a timer needs to be started before releasing the PDU Session or deactivating the UP connection for the EDN or LADN. The SMF 32 then starts the timer.

In step 1203, the SMF 32 detects the expiration of the timer. In step 1204, after the timer expires, the SMF 32 releases the PDU Session for the EDN or LADN or deactivates the UP connection. Although not illustrated, the procedure for releasing the PDU Session or deactivating the UP connection involves signaling between the SMF 32 and the UPF 33, as well as signaling between the SMF 32 and the UE 1 via the AMF 31. The procedure for releasing the PDU Session or deactivating the UP connection may be similar to the procedure specified in Non-Patent Literature 2, Section 4.3.4.2 or Section 4.3.7.

According to the example described in this example embodiment, if the UE 1 has moved out of an EDN service area or out of a LADN service area, the SMF 32 waits for the expiration of a predetermined time to wait for the completion of an ACR procedure before initiating the release of a PDU Session or the deactivation of a UP connection for the EDN or LADN. This can contribute to preventing failed ACR procedures when the UE 1 moves between different EDNs corresponding to different LADNs.

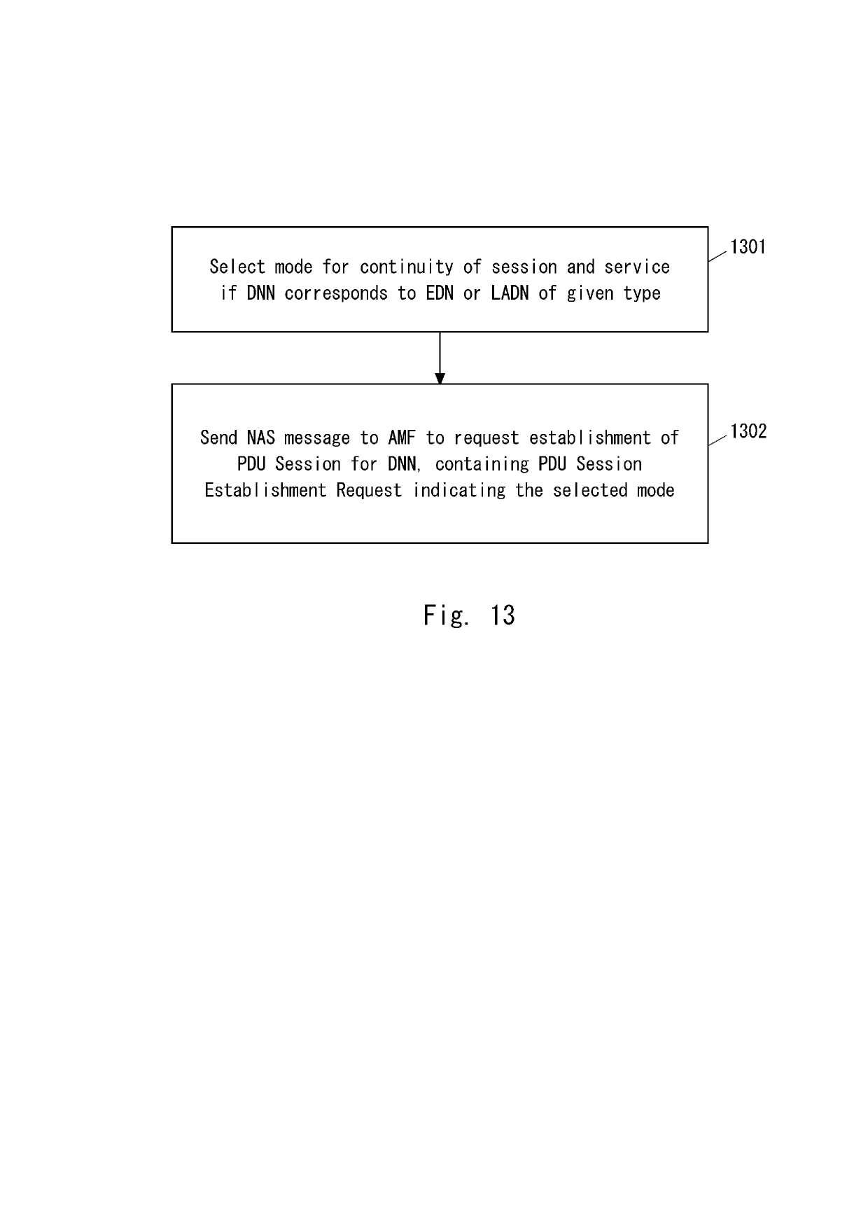

In this example embodiment, the UE 1 may perform the actions shown in FIG. 13 during the establishment of a PDU Session. In step 1301, the NAS layer of the UE 1 selects a mode for continuity of session and service if a DNN (UE requested DNN) corresponds to an EDN or LADN of a given type. As already explained, in the terminology used in this specification, the mode for continuity of session and service involves establishing a new PDU Session service for a second DNN different from a first DNN before releasing the old PDU Session with the first DNN when the UE 1 has moved out of the LADN service area corresponding to the first DNN. In an example, the second DNN is the target DNN to which the application context is transferred from the first DNN. The selection policy of the mode for continuity of session and service may be configured in the UE 1 as part of the UE Route Selection Policy (URSP). The policy may be preconfigured in the UE 1. The policy may be supplied by the PCF 34 to the UE 1 via the AMF 31 in the registration procedure.

In step 1302, the UE 1 sends a NAS message to the AMF 31 to request the establishment of a PDU Session for the DNN, containing a PDU Session Establishment Request indicating the selected mode for continuity of session and service.

According to this operation of the UE 1, when the UE 1 has moved out of an LADN service area corresponding to a first DNN, the UE 1 can establish a new PDU Session service for a second DNN that is different from the first DNN before releasing the old PDU Session with the first DNN. This can contribute to preventing failed ACR procedures when the UE 1 moves between different EDNs corresponding to different LADNs.

### Fifth Example Embodiment

The example network architecture according to this example embodiment is similar to the examples described with reference to FIGS. 1 through 3.

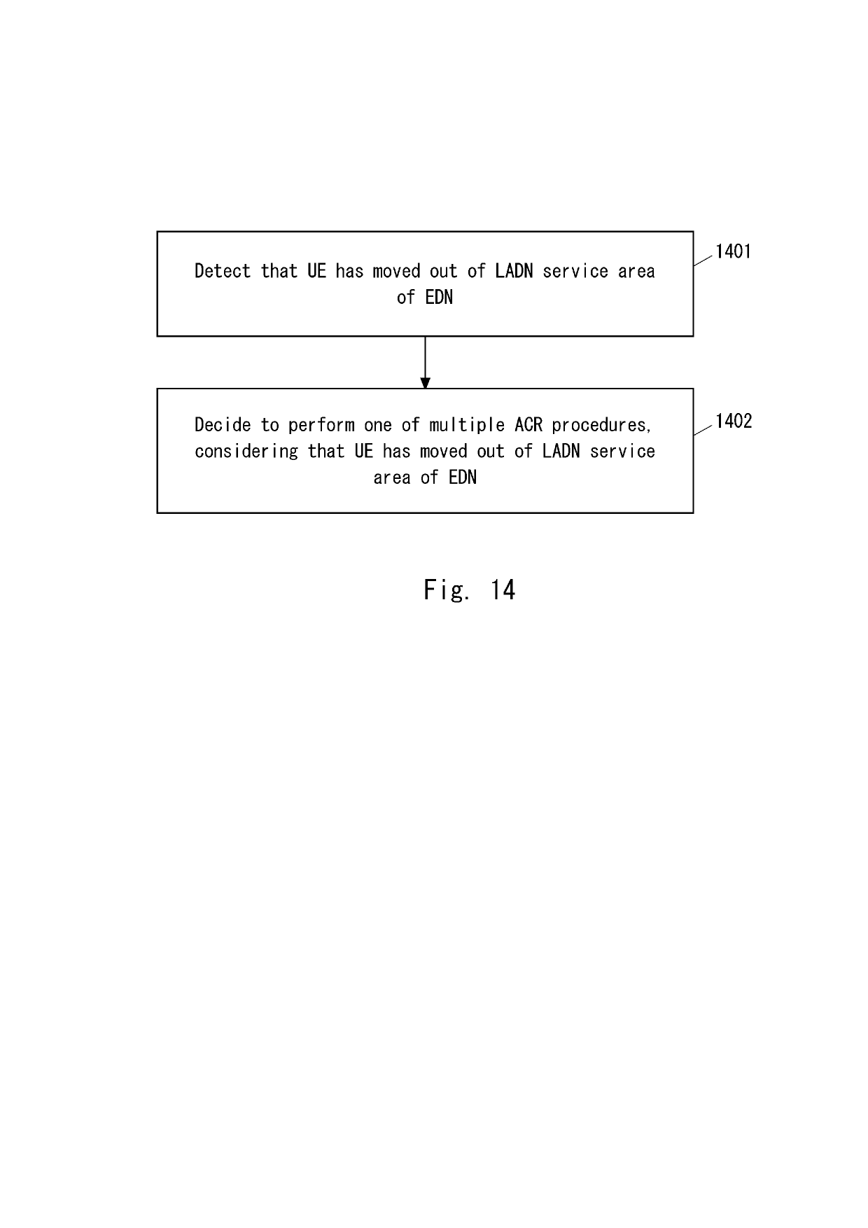

The UE 1 in this example embodiment provides EEC functionality. The EEC 11 of the UE 1 decides to perform one of multiple ACR procedures, considering that the UE 1 has moved out of an LADN service area associated with a first EDN. FIG. 14 shows an example of how the UE 1 operates. In step 1401, the EEC 11 detects that the UE has moved out of an LADN service area associated with an EDN. In step 1402, the EEC 11 decides to perform one of multiple ACR procedures, considering that the UE 1 has moved out of the LADN service area of a first EDN.

In an example, when the UE 1 moves out of the LADN service area associated with the first EDN, the EEC 11 selects and executes an ACR procedure that does not involve any message exchange between the EEC 11 and the S-EES in the first EDN. This ACR procedure may be the ACR procedure via T-EES (i.e., EEC executed ACR via T-EES) described in Section 8.8.2.6 of Non-Patent Literature 3. In other words, when the UE 1 has moved out of the LADN service area associated with the first EDN, the EEC 11 selects and executes an ACR procedure performed via a Target EES (T-EES) belonging to a second EDN that is different from the first EDN. In an example, these actions may be performed when the UE 1 has moved out of the LADN service area associated with the first EDN and the PDU Session for the first EDN is not subject to the mode for continuity of session and service.

The NAS layer of the UE 1 may send a notification to the EEC 11 of the UE 1 in response to detecting that the UE 1 is outside the LADN service area associated with the first EDN. This notification may indicate the mode for session and service continuity applicable to the PDU Session for the first EDN. In addition, the notification may indicate the Tracking Area Identity (TAI) corresponding to the location of the UE 1 outside of this LADN service area. The NAS layer of the UE 1 may retrieve the TAI based on a System Information Block (SIB) broadcast in the AN to which the UE 1 is moving. The selection of a T-EES based on the TAI may be made on the basis of information already provided in the UE 1. This information may be pre-configured in the UE 1. Alternatively, the information may be provided by the ECS 6 to the UE 1 in the service provisioning procedure.

According to the operation of the UE 1 described in this example embodiment, when the UE 1 moves from the first EDN (LADN) to the second EDN (LADN), if the continuation of the PDU Session for the first EDN (LADN) is not guaranteed, the EEC 11 of the UE 1 selects and executes any ACR procedure that does not involve any message exchange between the EEC 11 and the S-EES within the first EDN. This can contribute to preventing failed ACR procedures when the UE 1 moves between different EDNs corresponding to different LADNs.

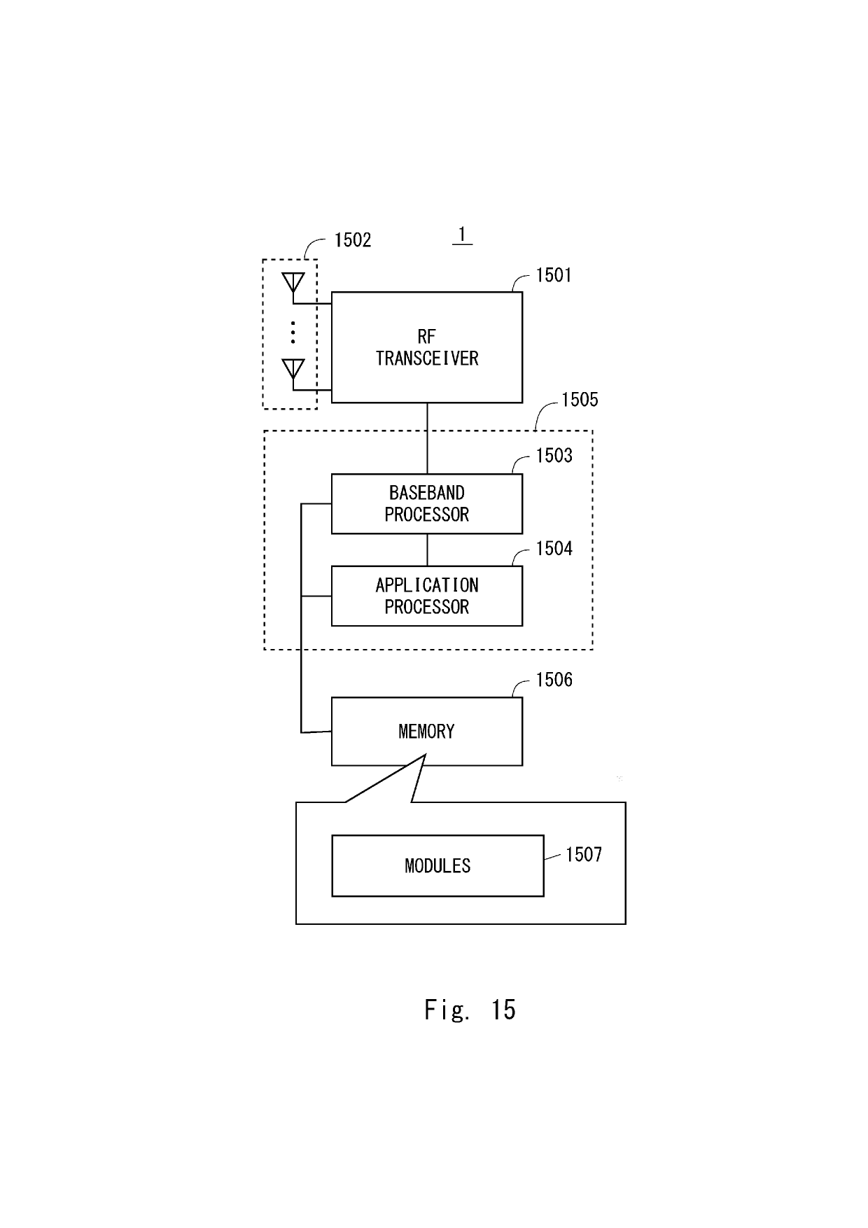

The following provides configuration examples of the UE 1, AF 5, AMF 31, SMF 32, and NEF 36 according to the above-described example embodiments. FIG. 15 is a block diagram showing an example configuration of the UE 1. A Radio Frequency (RF) transceiver 1501 performs analog RF signal processing to communicate with RAN nodes. The RF transceiver 1501 may include a plurality of transceivers. The analog RF signal processing performed by the RF transceiver 1501 includes frequency up-conversion, frequency down-conversion, and amplification. The RF transceiver 1501 is coupled to an antenna array 1502 and a baseband processor 1503. The RF transceiver 1501 receives modulated symbol data (or OFDM symbol data) from the baseband processor 1503, generates a transmission RF signal, and supplies the transmission RF signal to the antenna array 1502. Further, the RF transceiver 1501 generates a baseband reception signal based on a reception RF signal received by the antenna array 1502 and supplies the baseband reception signal to the baseband processor 1503. The RF transceiver 1501 may include an analog beamformer circuit for beam forming. The analog beamformer circuit includes, for example, a plurality of phase shifters and a plurality of power amplifiers.

The baseband processor 1503 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame) (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 1503 may include, for example, signal processing of Service Data Adaptation Protocol (SDAP), Packet Data Convergence Protocol (PDCP), Radio Link Control (RLC), Medium Access Control (MAC), and Physical (PHY) layers. The control-plane processing performed by the baseband processor 1503 may include processing of Non-Access Stratum (NAS) protocols, Radio Resource Control (RRC) protocols, MAC Control Elements (CEs), and Downlink Control Information (DCIs).

The baseband processor 1503 may perform Multiple Input Multiple Output (MIMO) encoding and pre-coding for beam forming.

The baseband processor 1503 may include a modem processor (e.g., Digital Signal Processor (DSP)) that performs the digital baseband signal processing and a protocol stack processor (e.g., a Central Processing Unit (CPU) or a Micro Processing Unit (MPU)) that performs the control-plane processing. In this case, the protocol stack processor, which performs the control-plane processing, may be integrated with an application processor 1504 described below.

The application processor 1504 is also referred to as a CPU, an MPU, a microprocessor, or a processor core. The application processor 1504 may include a plurality of processors (or processor cores). The application processor 1504 loads a system software program (Operating System (OS)) and various application programs (e.g., a call application, a WEB browser, a mailer, a camera operation application, and a music player application) from a memory 1506 or from another memory not shown and executes these programs, thereby providing various functions of the UE 1.

In some implementations, as represented by a dashed line (1505) in FIG. 15, the baseband processor 1503 and the application processor 1504 may be integrated on a single chip. In other words, the baseband processor 1503 and the application processor 1504 may be implemented in a single System on Chip (SoC) device 1505. The SoC device may be referred to as a Large-Scale Integration (LSI) or a chipset.

The memory 1506 is a volatile memory, a non-volatile memory, or a combination thereof. The memory 1506 may include a plurality of memory devices that are physically independent from each other. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1506 may include, for example, an external memory device that can be accessed from the baseband processor 1503, the application processor 1504, and the SoC 1505. The memory 1506 may include an internal memory device that is integrated in the baseband processor 1503, the application processor 1504, or the SoC 1505. Further, the memory 1506 may include a memory in a Universal Integrated Circuit Card (UICC).

The memory 1506 may store one or more software modules (computer programs) 1507 including instructions and data to perform the processing by the UE 1 described in the above example embodiments. In some implementations, the baseband processor 1503 or the application processor 1504 may load these software modules 1507 from the memory 1506 and execute the loaded software modules, thereby performing the processing of the UE 1 described in the above example embodiments with reference to the drawings.

The control-plane processing and operations performed by the UE 1 described in the above example embodiments can be achieved by elements other than the RF transceiver 1501 and the antenna array 1502, i.e., achieved by the memory 1506, which stores the software modules 1507, and one or both of the baseband processor 1503 and the application processor 1504.

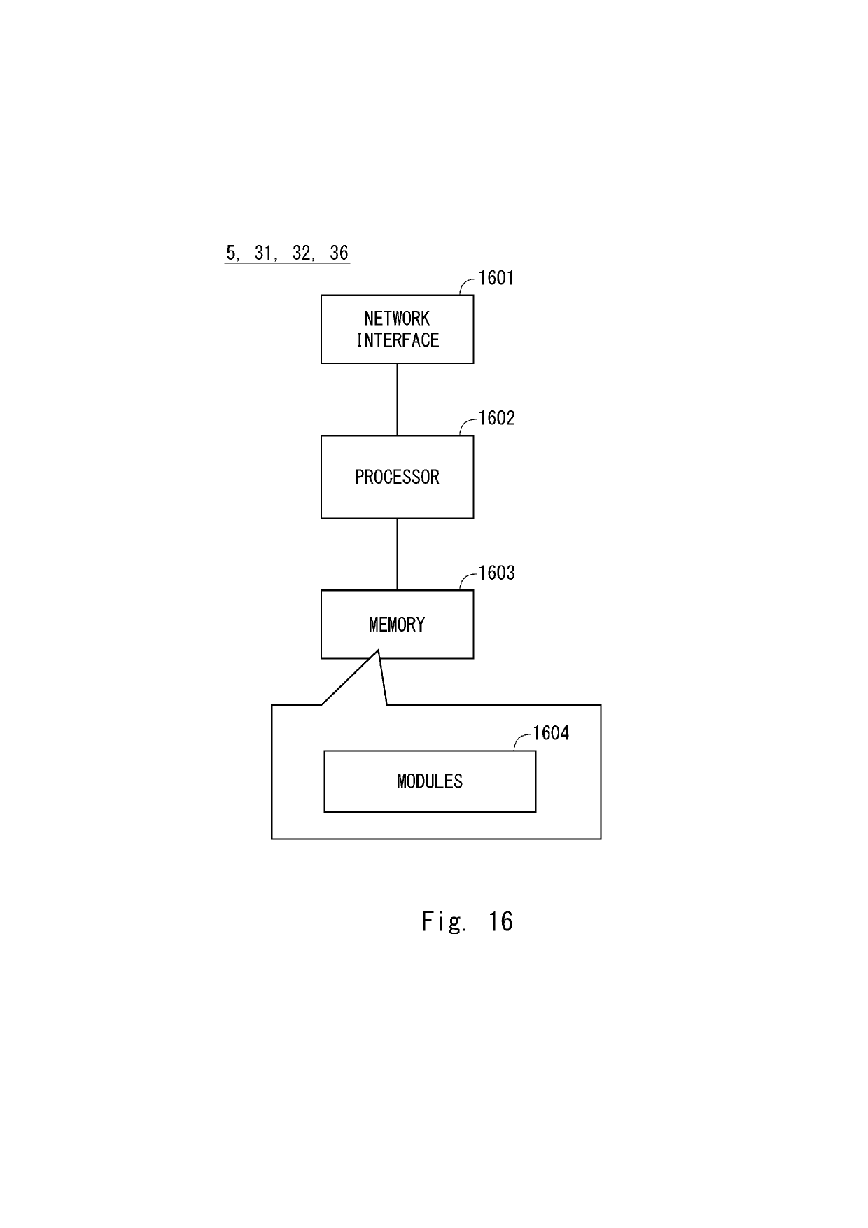

FIG. 16 shows an example configuration of an apparatus providing the functions of the AF 5. Other apparatuses providing network functions, such as the AMF 31, SMF 32, and NEF 36, etc., may have similar configurations to those shown in FIG. 16. Referring to FIG. 16, the AF 5 (or AMF 31, or SMF 32, or NEF 36) includes a network interface 1601, a processor 1602, and a memory 1603. The network interface 1601 is used to communicate with other network functions (NFs) or nodes. The network interface 1601 may include, for example, a network interface card (NIC) conforming to the IEEE 802.3 series.

The processor 1602 may be, for example, a microprocessor, a Micro Processing Unit (MPU), or a Central Processing Unit (CPU). The processor 1602 may include a plurality of processors.

The memory 1603 is composed of a volatile memory and a nonvolatile memory. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1603 may include a storage located apart from the processor 1602. In this case, the processor 1602 may access the memory 1603 via the network interface 1601 or an I/O interface not shown.

The memory 1603 may store one or more software modules (computer programs) 1604 including instructions and data to perform the processing of the AF 5 (or EES 71, or EAS 72) described in the above example embodiments. In some implementations, the processor 1602 may be configured to load the one or more software modules 1604 from the memory 1603 and execute the loaded software modules, thereby performing the processing of the AF 5 (or AMF 31, or SMF 32, or NEF 36) described in the above example embodiments.

As described using FIGS. 15 and 16, each of the processors in the UE 1, AF 5, AMF 31, SMF 32, and NEF 36 according to the example embodiments described above executes one or more programs, containing a set of instructions, to cause a computer to perform an algorithm described with reference to the drawings.

Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The above-described example embodiments are merely examples of applications of the technical ideas obtained by the inventors. These technical ideas are not limited to the above-described example embodiments and various modifications can be made thereto.

The whole or part of the example embodiments disclosed above can be described as, but not limited to, the following supplementary notes.

(Supplementary Note 1)

A Session Management Function (SMF) node comprising:

a memory; and

at least one processor coupled to the memory and configured to:

detect an event related to an Application Context Relocation (ACR) procedure after receiving a first event notification from an Access and Mobility management Function (AMF) node indicating that a User Equipment (UE) is out of an Edge Data Network (EDN) service area or out of a Local Area Data Network (LADN) service area; and

in response to detecting the event related to the ACR procedure, initiate a procedure for releasing a Protocol Data Unit (PDU) Session for an LADN associated with the LADN service area, a procedure for releasing a PDU Session for an EDN associated with the EDN service area, or a procedure for deactivating a User Plane (UP) connection for the PDU Session.

(Supplementary Note 2)

The SMF node according to Supplementary Note 1, wherein the event related to the ACR procedure includes after sending a second event notification from the SMF node to an Application Function (AF) node directly or via a Network Exposure Function (NEF) node, receiving a response to the second event notification directly from the AF node or via the NEF node.

(Supplementary Note 3)

The SMF node according to Supplementary Note 2, wherein the response indicates a completion of the ACR procedure involving a transfer of an application context from a Source Edge Application Server (S-EAS) to a Target EAS (T-EAS).

(Supplementary Note 4)

The SMF node according to Supplementary Note 1, wherein

the event related to the ACR procedure includes after sending a second event notification from the SMF node to an Application Function (AF) node directly or via a Network Exposure Function (NEF) node, receiving from a Policy Control Function (PCF) node a message instructing to initiate the procedure for releasing the PDU Session for the LADN associated with the LADN service area, the procedure for releasing the PDU Session for the EDN associated with the EDN service area, or the procedure for deactivating the UP connection for the PDU Session, and

the message is sent based on information provided by the AF node to the PCF node via the NEF node and a Unified Data Management (UDM) node.

(Supplementary Note 5)

The SMF node according to any one of Supplementary Notes 2 to 4, wherein the second event notification includes notification of information indicating that the UE is out of the EDN service area or out of the LADN service area.

(Supplementary Note 6)

The SMF node according to any one of Supplementary Notes 2 to 4, wherein the second event notification includes a prior notification of release of the PDU Session for the EDN, a prior notification of release of the PDU Session for the LADN, or a prior notification of deactivation of the UP connection.

(Supplementary Note 7)

The SMF node according to any one of Supplementary Notes 2 to 6, wherein the at least one processor is configured to:

receive a request from the AF node or the NEF node to subscribe to a service of providing the second event notification about the PDU Session; and

detect the event related to the ACR procedure after receiving the first event notification, provided that the request includes an indication instructing that a response from the AF node be awaited before initiating the procedure for releasing the PDU Session for the LADN associated with the LADN service area, the procedure for releasing the PDU Session for the EDN associated with the EDN service area, or the procedure for deactivating the UP connection for the PDU Session.

(Supplementary Note 8)

The SMF node according to any one of Supplementary Notes 1 to 7, wherein the event related to the ACR procedure includes expiration of a time period to wait for completion of the ACR procedure.

(Supplementary Note 9)

The SMF node according to Supplementary Note 8, wherein the at least one processor is configured to start a timer to count the time period to wait for the completion of the ACR procedure.

(Supplementary Note 10)

The SMF node according to Supplementary Note 9, wherein the at least one processor is configured to determine, based on a Data Network Name (DNN) of the LADN or EDN, whether the timer is required to start before the procedure for releasing the PDU Session or the procedure for deactivating the UP connection.

(Supplementary Note 11)

The SMF node according to Supplementary Note 9, wherein the at least one processor is configured to determine, based on a type of the LADN or EDN, whether the timer is required to start before the procedure for releasing the PDU Session or the procedure for deactivating the UP connection.

(Supplementary Note 12)

The SMF node according to Supplementary Note 9, wherein the at least one processor is configured to determine whether the timer is required to start before the procedure for releasing the PDU Session or the procedure for deactivating the UP connection, based on whether or not the LADN or LADN is associated with the timer.

(Supplementary Note 13)

The SMF node according to any one of Supplementary Notes 1 to 12, wherein the LADN service area or the EDN service area is a set of one or more Tracking Areas (TAs).

(Supplementary Note 14)

A method performed by a Session Management Function (SMF) node, the method comprising:

detecting an event related to an Application Context Relocation (ACR) procedure after receiving a first event notification from an Access and Mobility management Function (AMF) node indicating that a User Equipment (UE) is out of an Edge Data Network (EDN) service area or out of a Local Area Data Network (LADN) service area; and

in response to detecting the event related to the ACR procedure, initiating a procedure for releasing a Protocol Data Unit (PDU) Session for an LADN associated with the LADN service area, a procedure for releasing a PDU Session for an EDN associated with the EDN service area, or a procedure for deactivating a User Plane (UP) connection for the PDU Session.

(Supplementary Note 15)

A program for causing a computer to perform a method for a Session Management Function (SMF) node, the method comprising:

detecting an event related to an Application Context Relocation (ACR) procedure after receiving a first event notification from an Access and Mobility management Function (AMF) node indicating that a User Equipment (UE) is out of an Edge Data Network (EDN) service area or out of a Local Area Data Network (LADN) service area; and

in response to detecting the event related to the ACR procedure, initiating a procedure for releasing a Protocol Data Unit (PDU) Session for an LADN associated with the LADN service area, a procedure for releasing a PDU Session for an EDN associated with the EDN service area, or a procedure for deactivating a User Plane (UP) connection for the PDU Session.

(Supplementary Note 16)

An Application Function (AF) node comprising:

a memory; and

at least one processor coupled to the memory and configured to:

receive an event notification from a Session Management Function (SMF) node directly or through a Network Exposure Function (NEF) node; and

send a response to the event notification to the SMF node directly or through the NEF node after an Application Context Relocation (ACR) procedure involving a transfer of an application context from a Source Edge Application Server (S-EAS) to a Target EAS (T-EAS) is completed,

wherein the response is a message that causes the SMF node to initiate a procedure for releasing a Protocol Data Unit (PDU) Session for a Local Area Data Network (LADN), a procedure for releasing a PDU Session for an Edge Data Network (EDN), or a procedure for deactivating a User Plane (UP) connection for the PDU Session.

(Supplementary Note 17)

The AF node according to Supplementary Note 16, wherein the event notification indicates that a User Equipment (UE) is out of a service area of the EDN or out of a service area of the LADN, indicates a prior notification of a release of the PDU Session for the LADN, indicates a prior notification of a release of the PDU Session for the EDN, or indicates a prior notification of a deactivation of the UP connection for the PDU Session.

(Supplementary Note 18)

A method performed by an Application Function (AF) node, the method comprising:

receiving an event notification from a Session Management Function (SMF) node directly or through a Network Exposure Function (NEF) node; and

sending a response to the event notification to the SMF node directly or through the NEF node after an Application Context Relocation (ACR) procedure involving a transfer of an application context from a Source Edge Application Server (S-EAS) to a Target EAS (T-EAS) is completed,

wherein the response is a message that causes the SMF node to initiate a procedure for releasing a Protocol Data Unit (PDU) Session for a Local Area Data Network (LADN), a procedure for releasing a PDU Session for an Edge Data Network (EDN), or a procedure for deactivating a User Plane (UP) connection for the PDU Session.

(Supplementary Note 19)

A program for causing a computer to perform a method for an Application Function (AF) node, the method comprising:

receiving an event notification from a Session Management Function (SMF) node directly or through a Network Exposure Function (NEF) node; and

sending a response to the event notification to the SMF node directly or through the NEF node after an Application Context Relocation (ACR) procedure involving a transfer of an application context from a Source Edge Application Server (S-EAS) to a Target EAS (T-EAS) is completed,

wherein the response is a message that causes the SMF node to initiate a procedure for releasing a Protocol Data Unit (PDU) Session for a Local Area Data Network (LADN), a procedure for releasing a PDU Session for an Edge Data Network (EDN), or a procedure for deactivating a User Plane (UP) connection for the PDU Session.

(Supplementary Note 20)

A User Equipment (UE) comprising:

a memory; and

at least one processor coupled to the memory and configured to:

if a first Data Network Name (DNN) corresponds to a Local Area Data Network (LADN) of a given type, select a mode for continuity of session and service; and

send a Non-Access Stratum (NAS) message containing a PDU Session Establishment Request indicating the selected mode to an Access and Mobility management Function (AMF) node to request an establishment of a first Protocol Data Unit (PDU) Session for the first DNN,

wherein the mode for continuity of session and service comprises establishing a second PDU Session for a second DNN to which an application context is transferred from the first DNN before the first PDU Session is released when the UE has moved out of an LADN service area corresponding to the first DNN.

(Supplementary Note 21)

A method performed by a User Equipment (UE), the method comprising:

if a first Data Network Name (DNN) corresponds to a Local Area Data Network (LADN) of a given type, selecting a mode for continuity of session and service; and

sending a Non-Access Stratum (NAS) message containing a PDU Session Establishment Request indicating the selected mode to an Access and Mobility management Function (AMF) node to request an establishment of a first Protocol Data Unit (PDU) Session for the first DNN,

wherein the mode for continuity of session and service comprises establishing a second PDU Session for a second DNN to which an application context is transferred from the first DNN before the first PDU Session is released when the UE has moved out of an LADN service area corresponding to the first DNN.

(Supplementary Note 22)

A program for causing a computer to perform a method for a User Equipment (UE), the method comprising:

if a first Data Network Name (DNN) corresponds to a Local Area Data Network (LADN) of a given type, selecting a mode for continuity of session and service; and

sending a Non-Access Stratum (NAS) message containing a PDU Session Establishment Request indicating the selected mode to an Access and Mobility management Function (AMF) node to request an establishment of a first Protocol Data Unit (PDU) Session for the first DNN,

wherein the mode for continuity of session and service comprises establishing a second PDU Session for a second DNN to which an application context is transferred from the first DNN before the first PDU Session is released when the UE has moved out of an LADN service area corresponding to the first DNN.

(Supplementary Note 23)

A User Equipment (UE) comprising:

a memory; and

at least one processor coupled to the memory and configured to provide Edge Enabler Client (EEC) functionality, wherein the EEC functionality comprises determining which of a plurality of Application Context Relocation (ACR) procedures to perform, considering that the UE has moved out of a Local Area Data Network (LADN) service area associated with a first Edge Data Network (EDN).

(Supplementary Note 24)

The UE according to Supplementary Note 23, wherein the EEC functionality comprises selecting and performing an ACR procedure that does not involve any message exchange between the EEC and a Source Edge Enabler Server (S-EES) in the first EDN when the UE has moved out of the LADN service area of the first EDN.

(Supplementary Note 25)

The UE according to Supplementary Note 23, wherein the EEC functionality comprises selecting and performing an ACR procedure performed via a Target EES (T-EES) belonging to a second EDN different from the first EDN when the UE has moved out of the LADN service area associated with the first EDN.

(Supplementary Note 26)

The UE according to any one of Supplementary Notes 23 to 25, wherein the EEC functionality comprises performing one of the plurality of ACR procedures if a Protocol Data Unit (PDU) Session for the first EDN is not subject to a mode for continuity of session and service.

(Supplementary Note 27)

The UE according to any one of Supplementary Notes 23 to 26, wherein the at least one processor is configured to provide Non-Access Stratum (NAS) layer functionality,

wherein the NAS layer functionality comprises sending a notification to the EEC function in response to detecting that the UE is out of the LADN service area associated with the first EDN,

wherein the notification indicates a mode for continuity of session and service applied to a Protocol Data Unit (PDU) Session for the first EDN.

(Supplementary Note 28)

The UE according to Supplementary Note 27, wherein the notification indicates a Tracking Area Identity (TAI) corresponding to a location of the UE outside the LADN service area.

(Supplementary Note 29)

The UE according to Supplementary Note 28, wherein the EEC functionality comprises selecting a Target EES (T-EES) based on the TAI included in the notification.

(Supplementary Note 30)

A method performed by a User Equipment (UE), the method comprising:

providing Edge Enabler Client (EEC) functionality, wherein the EEC functionality comprises determining which of a plurality of Application Context Relocation (ACR) procedures to perform, considering that the UE has moved out of a Local Area Data Network (LADN) service area associated with a first Edge Data Network (EDN).

(Supplementary Note 31)

A program for causing a computer to perform a method for a User Equipment (UE), the method comprising:

providing Edge Enabler Client (EEC) functionality, wherein the EEC functionality comprises determining which of a plurality of Application Context Relocation (ACR) procedures to perform, considering that the UE has moved out of a Local Area Data Network (LADN) service area associated with a first Edge Data Network (EDN).

This application is based upon and claims the benefit of priority from Japanese Patent Application No. 2021-084223, filed on May 18, 2021, the disclosure of which is incorporated herein in its entirety by reference.

### Reference Signs List

1 User Equipment (UE)

2 Access Network (AN)

3 3GPP Coe Network

5 Application Function (AF)

6 Edge Configuration Server (ECS)

7 Edge Data Network (EDN)

8 Public Land Mobile Network (PLMN)

11 Edge Enabler Client (EEC)

12 Application client (AC)

31 Access and Mobility management Function (AMF)

32 Session Management Function (SMF)

33 User Plane Function (UPF)

34 Policy Control Function (PCF)

35 Unified Data Management (UDM)

36 Network Exposure Function (NEF)

41, 42 Local Area Data Network (LADN)

43 Data Network (DN)

71 Edge Enabler Server (EES)

72 Edge Application Server (EAS)

1503 Baseband Processor

1504 Application Processor

1506 Memory

1507 Modules

1602 Processor

1603 Memory

1604 Modules

1. A method performed by a Session Management Function (SMF), the method comprising:
establishing a Protocol Data Unit (PDU) session between a user equipment (UE) and a first PDU Session Anchor (PSA);
receiving, from an Application Function (AF) via a Network Exposure Function (NEF), a first message comprising a first timer, the first timer relating to how long the first PSA corresponding to the PDU session is to be maintained; and
maintaining the first PSA corresponding to the PDU session based on the first timer in response to an edge relocation triggered by a user equipment mobility.

2. A user equipment (UE) comprising:
one or more memories storing instructions; and
one or more processors configured to process the instructions to control the UE to:
transmit, to an Access and Mobility management Function (AMF), a Protocol Data Unit (PDU) session establishment request message for establishing a PDU session between the UE and a first PDU Session Anchor (PSA), wherein
in a case of an edge relocation triggered by a UE mobility, the first PSA corresponding to the PDU session is maintained based on a first timer relating to how long the first PSA corresponding to the PDU session is to be maintained.

3. A method performed by a user equipment (UE), the method comprising:
transmit, to an Access and Mobility management Function (AMF), a Protocol Data Unit (PDU) session establishment request message for establishing a PDU session between the UE and a first PDU Session Anchor (PSA), wherein
in a case of an edge relocation triggered by a UE mobility, the
first PSA corresponding to the PDU session is maintained based on a first timer relating to how long the first PSA corresponding to the PDU session is to be maintained.
